(19) United States
(12) Patent Application Publication
(10) Pub. No.: US 2021/0255561 A1
(43) Pub. Date: Aug. 19, 2021

(54) LIQUID ELECTROPHOTOGRAPHIC INK COMPOSITION

(71) Applicant: Hewlett-Packard Development Company, L.P., Spring, TX (US)

(72) Inventors: Benjamin Dayan, Nes Ziona (IL); Juilia KORNILOV, Nes Ziona (IL); Ariel LITWAK, Nes Ziona (IL); Gil BAR-HAIM, Nes Ziona (IL); Tal ROSENTHAL, Nes Ziona (IL)

(73) Assignee: Hewlett-Packard Development Company, L.P., Spring, TX (US)

(21) Appl. No.: 17/049,771

(22) PCT Filed: Aug. 29, 2018
(86) PCT No.: PCT/US2018/048511

§ 371 Date: Oct. 22, 2020

(51) Int. Cl. G03G 9/135; C09D 11/033; C09D 11/037; C09D 11/10; G03G 9/12

(52) U.S. Cl. CPC G03G 9/1355; C09D 11/033; G03G 9/122; C09D 11/10; C09D 11/037

(57) ABSTRACT

Herein is described a liquid electrophotographic (LEP) ink composition comprising: a hydrocarbon carrier liquid; a resin; a colorant comprising a conjugated compound; and a component selected from: an amine-containing basic dispersant having a total base number greater than about 300 mgKOH/g material; or an amine-containing compound having a pKa of 8 or more at 25° C.; or urea.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, a liquid electrophotographic (LEP) ink composition including ink particles in a liquid carrier can be charged by applying a developing voltage to the LEP ink composition to provide charged ink particles which are then brought into contact with the selectively charged photoconductive surface. The charged ink particles adhere to the image areas of the latent image while the background areas remain clean. The image is then transferred to a print substrate (e.g. paper) directly or, by being first transferred to an intermediate transfer member, which can be a soft swelling blanket, which is often heated to fuse the solid image and evaporate the liquid carrier, and then to the print substrate.

Some previous LEP ink compositions comprising cyan, magenta or black colorants have been found to suffer from electrical fatigue. Electrical fatigue may cause the charging property of a LEP ink composition to change, for example an increase in particle conductivity, when exposed to electrical fields for prolonged periods of time. If particle conductivity of the LEP ink composition changes, the number of particles transferred to the photoconductive surface in a liquid electrostatic printing process changes for a given developing voltage, resulting in a different thickness of ink being transferred to the print substrate which may cause a decline in the optical density of the printed image. Some previous solutions to this problem include correcting the developing voltage applied to the LEP ink composition in order to preserve the optical density.

### BRIEF DESCRIPTION OF THE FIGURES

FIG. 1 is a schematic illustration of an example of a liquid electrophotographic (LEP) printing apparatus for printing an LEP ink composition.

FIG. 2 is a graph showing the change in optical density of a reference cyan ink composition against the number of impressions printed (in kimp);

FIG. 3 is a graph showing the particle conductivity (PC) of a reference cyan ink composition against the number of impressions printed (in kimp).; and

FIG. 4a is a graph showing the change in particle conductivity (ΔPC) for LEP ink compositions containing different amounts of mono ethanol amine (MEA); and

FIG. 4b is a graph showing the ΔPC for LEP ink compositions containing different amounts of urea.

### DETAILED DESCRIPTION

Before the compositions, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “liquid carrier”, “carrier liquid”, “carrier,” or “carrier vehicle” refers to the fluid in which the resin, colorant, basic dispersant, charge directors and/or other additives can be dispersed to form a liquid electrostatic ink or electrophotographic ink. Liquid carriers can include a mixture of a variety of different agents, such as surfactants, co-solvents, viscosity modifiers, and/or other possible ingredients.

As used herein, “electrostatic ink composition” generally refers to an ink composition, which may be in liquid form, generally suitable for use in an electrostatic printing process, sometimes termed an electrophotographic printing process. The electrostatic ink composition may include chargeable particles of resin and a colorant dispersed in a liquid carrier, which may be as described herein.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” of a polymer/resin refers to the mass of potassium hydroxide (KOH) in milligrams that neutralizes one gram of the polymer/resin comprising acidic groups. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise. In some examples, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic(ally) printing” or “electrophotographic(ally) printing” generally refers to the process that provides an image that is transferred from a photo imaging substrate or plate either directly or indirectly via an intermediate transfer member to a print substrate, e.g. a paper substrate. As such, the image is not substantially absorbed into the photo imaging substrate or plate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrophotographic ink composition to an electric field, e.g. an electric field having a field strength of 1000 V/cm or more, in some examples 1000 V/mm or more.

As used herein, the term “about” is used to provide flexibility to a numerical range endpoint by providing that a given value may be a little above or a little below the endpoint. The degree of flexibility of this term can be dictated by the particular variable.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless specified otherwise, wt % values are to be taken as referring to a weight-for-weight (w/w) percentage of solids in the ink composition, and not including the weight of any carrier fluid present. As used herein, unless specified otherwise, the solids include any compound or mixture forming part of the LEP ink composition that remains on a print substrate after printing of the LEP ink composition, whether or not the compound or mixture is a liquid or a solid when initially combined with the other components of the LEP ink composition.

Electrical fatigue in liquid electrostatic printing processes may be observed as a reduction in optical density over time. It has been observed that the problem of electrical fatigue is particularly severe when running low print coverage jobs, for example a coverage of less than 40%, such as less than 30%, less than 20% or less than about 10%. It has also been observed that the problem of electrical fatigue is most prominent in inks comprising colorants having highly conjugated chemistry, e.g. cyan, black and magenta colorants, e.g. cyan and black colorants. One method of reducing electrical fatigue is to vary the developing voltage over a print run to tune the electrical field in order to preserve the optical density. However, it has been observed that increasing the developing voltage in an attempt to counter the electrical fatigue problem may lead to other problems such as deposition of ink particles in background areas and other print quality issues, particularly for colorants comprising a conjugated compound such as a conjugated aromatic compound, for example colorants comprising conjugated compounds (i.e. compounds with a conjugated chemistry) and having an acidic surface, for example a mildly acidic surface. Additionally, increasing the developing voltage to counteract the problem of electrical fatigue may only be effective up to the maximum developing voltage for a particular apparatus, after this the developing voltage cannot be increased and so the effect of electrical fatigue cannot be overcome.

It has been found that colorants comprising conjugated compound, which may be present in magenta, cyan and/or black colorants, are particularly affected by electrical fatigue, for example colorants comprising conjugated compounds and having an acidic surface, in particular colorants comprising conjugated compounds and having a mildly acidic surface. During printing, in particular, when running low coverage print jobs, the colorant particles are exposed to a high electric field many times. Without being bound by any particular theory, it is believed that this repeated exposure to high electric fields may result in electrostatic separation in the colorant particles by detaching a proton from acid residues on the colorant particle surface, creating an excess negative charge that is electrically stabilized by the conjugated system of colorants that comprise a conjugated compound. It has been found that the particle conductivity (PC) of colorants comprising conjugated compounds may increase during a print run. It is believed that this increase in particle conductivity may be a result of the electrostatic separation. Increased particle conductivity may reduce the amount of ink transferred to the developer roller of the LEP printing apparatus (e.g. due to repulsive forces and mobility limitations of the colorant particles) which may in turn reduce the optical density.

It has surprisingly been found that providing an LEP ink composition as described herein may reduce the problem of electrical fatigue as well as minimising side effects such as background effects and other print quality issues (e.g. increased dot size and blanket memory effects), for example print quality problems which may be caused by high developing voltages.

Unless otherwise stated, any feature described herein can be combined with any aspect or any other feature described herein.

In an aspect there is provided a liquid electrophotographic (LEP) ink composition. The LEP ink composition may comprise:

a hydrocarbon carrier liquid;

a resin;

a colorant comprising a conjugated compound; and

a component selected from:
an amine-containing basic dispersant having a total base number (TBN) greater than about 300 mgKOH/g; or
an amine-containing compound having a pKa of 8 or more at 25° C.; or urea.

In an aspect there is provided a liquid electrophotographic (LEP) ink composition comprising:

a hydrocarbon carrier liquid;

a resin;

a colorant comprising a conjugated compound; and

a component selected from:
an amine-containing basic dispersant having a total base number greater than about 300 mgKOH/g in an amount of up to about 10 wt. % by weight of the colorant; or
an amine-containing compound having a pKa of 8 or more at 25° C.; or
urea.

In an aspect there is provided a liquid electrophotographic (LEP) ink composition comprising:
a hydrocarbon carrier liquid;
a resin;
a colorant comprising a conjugated compound; and
up to about 2 wt. % by total weight solids of the composition of a component selected from:
   an amine-containing basic dispersant having a total base number greater than about 300 mgKOH/g; or
   an amine-containing compound having a pKa of 8 or more at 25° C.; or urea.

In another aspect there is provided a method of producing a LEP ink composition. The method may comprise combining:

a hydrocarbon carrier liquid;

a resin;

a colorant comprising a conjugated compound; and

a component selected from
an amine-containing basic dispersant having a total base number (TBN) greater than about 300 mgKOH/g; or
an amine-containing compound having a pKa of 8 or more at 25° C.; or
urea.

In another aspect there is provided a method of producing a LEP ink composition, the method comprising combining:

a hydrocarbon carrier liquid;

a resin;

a colorant comprising a conjugated compound; and

a component selected from
an amine-containing basic dispersant having a total base number greater than about 300 mgKOH/g in an amount of up to about 10 wt. % by weight of the colorant; or
an amine-containing compound having a pKa of 8 or more at 25° C.; or
urea.

In another aspect there is provided a method of printing an LEP ink composition, the method comprising:

providing an LEP ink composition comprising:
a hydrocarbon carrier liquid;
a resin;
a colorant comprising a conjugated compound; and
a component selected from
   an amine-containing basic dispersant having a total base number (TBN) greater than about 300 mgKOH/g; or
   an amine-containing compound having a pKa of 8 or more at 25° C.; or
   urea; and

liquid electrostatically printing the LEP ink composition onto a substrate.

In another aspect there is provided a method of printing an LEP ink composition, the method comprising:

providing an LEP ink composition comprising:
a hydrocarbon carrier liquid;
a resin;
a colorant comprising a conjugated compound; and
a component selected from
   an amine-containing basic dispersant having a total base number greater than about 300 mgKOH/g in an amount of up to about 10 wt. % by weight of the colorant; or
   an amine-containing compound having a pKa of 8 or more at 25° C.; or
   urea; and

liquid electrostatically printing the LEP ink composition onto a substrate.

In another aspect there is provided a liquid electrophotographic (LEP) ink composition. The LEP ink composition may comprise:

a hydrocarbon carrier liquid;

a resin;

a colorant comprising a conjugated compound; and

a component selected from:
an amine-containing basic dispersant having a total base number greater than about 300 mgKOH/g in an amount of up to about 10 wt. % by weight of the colorant; or
an amine-containing compound having a pKa of 8 or more at 25° C., the amine compound present in an amount of up to about 15 wt. % by weight of the colorant; or
urea in an amount of up to about 20 wt. % by weight of the colorant.

In another aspect there is provided a liquid electrophotographic (LEP) ink composition. The LEP ink composition may comprise:
a hydrocarbon carrier liquid;
a resin;
a colorant comprising a conjugated compound; and
up to about 2 wt. % by total weight solids of the composition of a component selected from:
   an amine-containing basic dispersant having a total base number greater than about 300 mgKOH/g in an amount of up to about 10 wt. % by weight of the colorant; or
   an amine-containing compound having a pKa of 8 or more at 25° C., the amine compound present in an amount of up to about 15 wt. % by weight of the colorant; or
   urea in an amount of up to about 20 wt. % by weight of the colorant.

In a further aspect there is provided a liquid electrophotographic (LEP) ink composition. The LEP ink composition may comprise:
a hydrocarbon carrier liquid;
a resin in an amount of 5 wt. % to 95 wt. % by total weight solids of the composition;
a colorant comprising a conjugated compound in an amount of 5 wt. % to 80 wt. % total weight solids of the composition; and
up to about 2 wt. % by total weight solids of the composition of a component selected from:
   an amine-containing basic dispersant having a total base number greater than about 300 mgKOH/g in an amount of up to about 10 wt. % by weight of the colorant; or
   an amine-containing compound having a pKa of 8 or more at 25° C., the amine compound present in an amount of up to about 15 wt. % by weight of the colorant; or
urea in an amount of up to about 20 wt. % by weight of the colorant.

In a further aspect there is provided a method of electrostatic printing an LEP ink composition. The method may comprise:

providing a LEP ink composition comprising:
a hydrocarbon carrier liquid;
a resin;
a colorant comprising a conjugated compound; and
a component selected from:
   an amine-containing basic dispersant having a total base number greater than about 300 mgKOH/g in an amount of up to about 10 wt. % by weight of the colorant; or
   an amine-containing compound having a pKa of 8 or more at 25° C.; or
urea; and

liquid electrostatically printing the LEP ink composition onto a substrate.

### LEP Ink Composition

The LEP ink composition comprises a component selected from an amine-containing basic dispersant having a total base number (TBN) greater than about 300 mgKOH/g material, wherein the amine-containing basic dispersant is present in an amount of 10 wt. % or less by weight of the colorant; or an amine-containing compound having a pKa of 8 or more at 25° C.; or urea.

In some examples, the LEP ink composition may comprise an amine-containing basic dispersant having a total base number greater than about 300 mgKOH/g material. In some examples, the amine-containing basic dispersant is present in an amount of up to 10 wt. % by weight of the colorant.

In some examples, the LEP ink composition may comprise an amine-containing compound having a pKa of 8 or more at 25° C. In some examples, the amine-containing compound having a pKa of 8 or more is present in an amount of up to about 15 wt. % by weight of the colorant, in some examples, up to about 10 wt. % by weight of the colorant.

In some examples, the LEP ink composition may comprise urea. In some examples, urea is present in an amount up to about 20 wt. % by weight of the colorant.

### Colorant

The LEP ink (pigmented LEP ink) includes a colorant comprising a conjugated compound. The colorant comprising a conjugated compound may be selected from a magenta colorant, a cyan colorant and a black colorant. The colorant comprising a conjugated compound may be a cyan colorant. The colorant may be a dye or pigment. The colorant can be any colorant compatible with the liquid carrier and useful for liquid electrophotographic printing. For example, the colorant may be present as pigment particles, or may comprise a resin (in addition to the polymers described herein) and a pigment.

In some examples, the colorant comprises a conjugated compound, for example an aromatic conjugated compound. As used herein “conjugated compound” is used to describe a compound comprising a conjugated system, i.e. a system which allows delocalised electrons, e.g. pi electrons, across adjacent atoms. A conjugated system may be a region of overlapping p-orbitals which may bridge single bonds within a molecule and allow the delocalization of electrons over at least a region of the molecule. Examples of conjugated compounds are phthalocyanins, carbon black (including graphite), quinacrodines, anthraquinones, antharones, diketopyrrolopyroles, perylenes, perinones, phthaleins, pyranthrones, indigoids, thioindigoids, pyrazoloquinazolones, heterocyclic compounds (for example a heterocyclic compound having conjugated chemistry, such as a nitrogen containing heterocyclic compound having conjugated chemistry, such as pyrrole diones), benzimidazolones, indanthrones, bisoxazines, violanthrones, isoviolanthrones, aryl-substituted triazines (for example, 2,4,6-aryl substituted 1,3,5-triazines), imine-substituted naphthols, azines, rhodamines or phenazines. Examples of conjugated compounds are phthalocyanins, carbon black, quinacrodines, anthraquinones, diketopyrrolopyroles, perylenes, perinones, pyranthrones, thioindigoids, pyrazoloquinazolones, bisoxazines, violanthrones, isoviolanthrones, aryl-substituted triazines (for example, 2,4,6-aryl substituted 1,3,5-triazines), imine-substituted naphthols, azines or phenazines.

In some examples, the colorant comprises a phthalocyanin, carbon black (for example carbon black including graphite), quinacrodine, anthraquinone, antharone, diketopyrrolopyrole, perylene, perinone, phthalein, pyranthrone, thioindigoid, pyrazoloquinazolone, heterocyclic compound (for example a heterocyclic compound having conjugated chemistry, such as a nitrogen containing heterocyclic compound having conjugated chemistry), benzimidazolone, indanthrone, bisoxazine, violanthrone, isoviolanthrone, aryl-substituted triazine, imine-substituted naphthol, azine, rhodamine or phenazine. In some examples, the colorant comprises a phthalocyanin, carbon black, quinacrodine, anthraquinone, diketopyrrolopyrole, perylene, perinone, pyranthrone, thioindigoid, pyrazoloquinazolone, bisoxazine, violanthrone, isoviolanthrone, aryl-substituted triazine (for example, 2,4,6-aryl substituted 1,3,5-triazine), imine-substituted naphthol, azine, rhodamine or phenazine.

In some examples, the colorant comprises a phthalocyanin, carbon black (for example carbon black including graphite), quinacrodine, anthraquinone, antharone, diketopyrrolopyrole, perylene, perinone, phthalein, pyranthrone, thioindigoid, pyrazoloquinazolone, pyrrole dione, benzimidazolone, or an indanthrone.

In some examples, the colorant comprises:

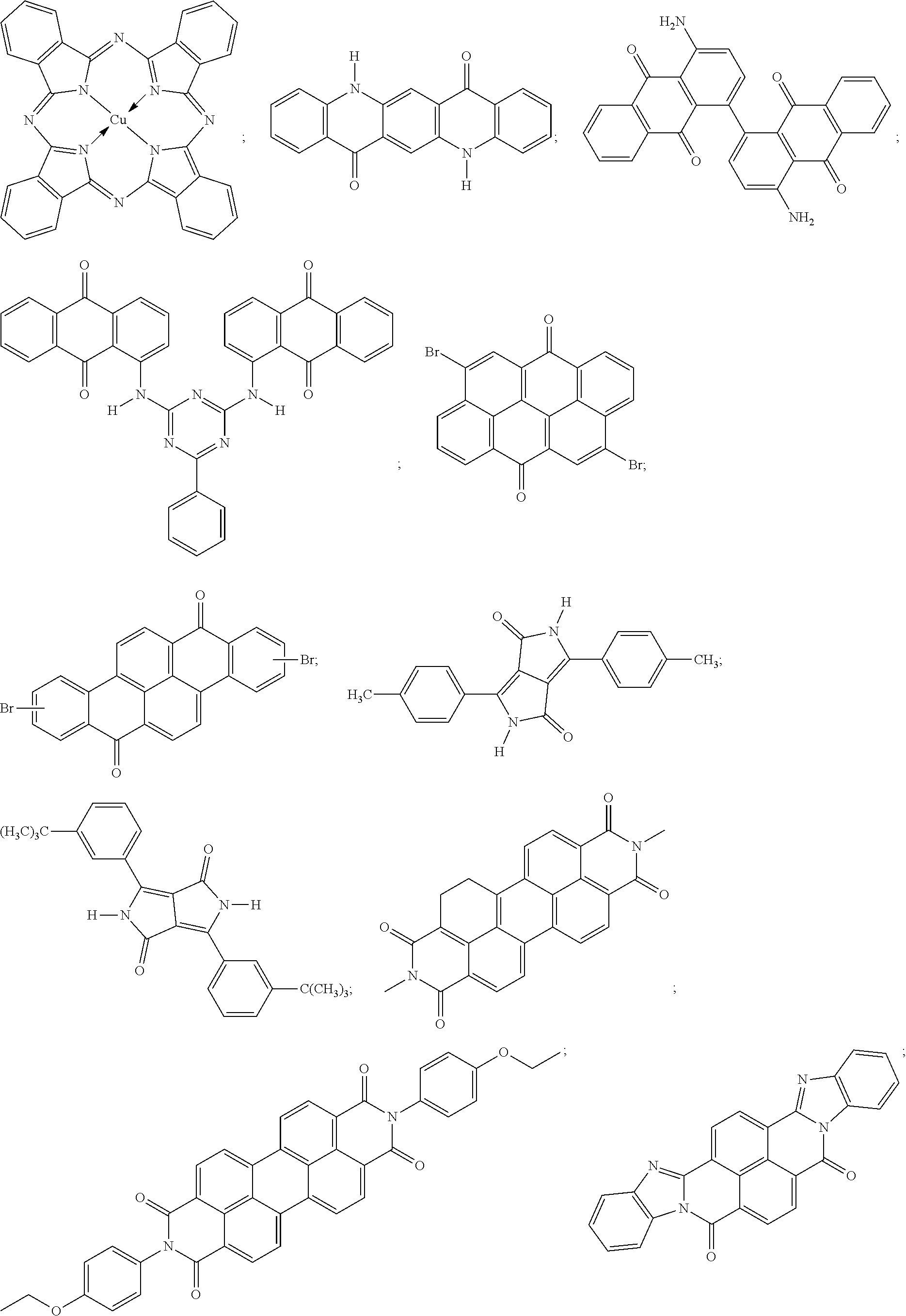

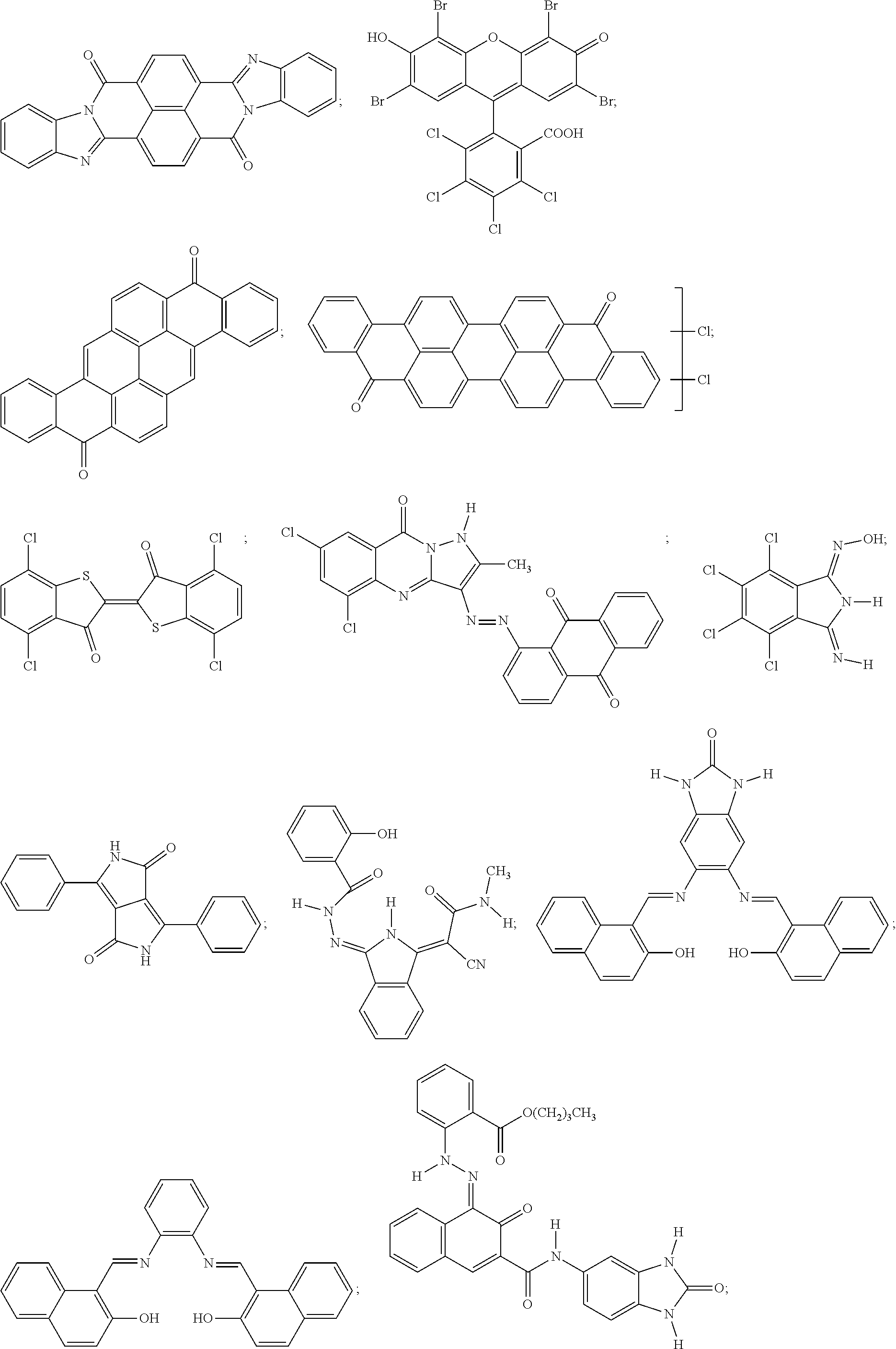

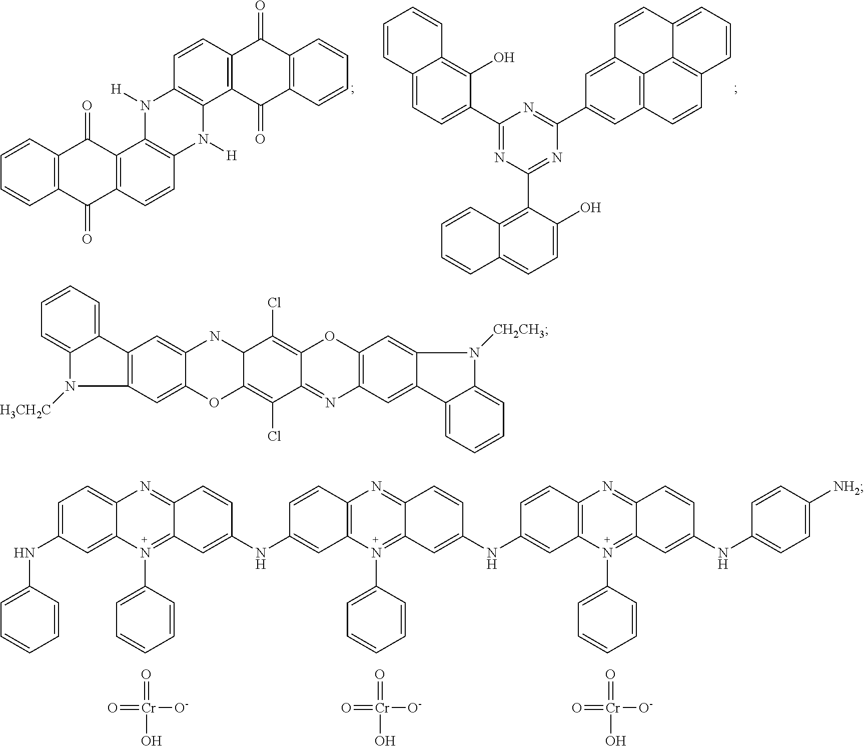

graphite; or derivatives thereof.

In some examples, the colorant comprises:

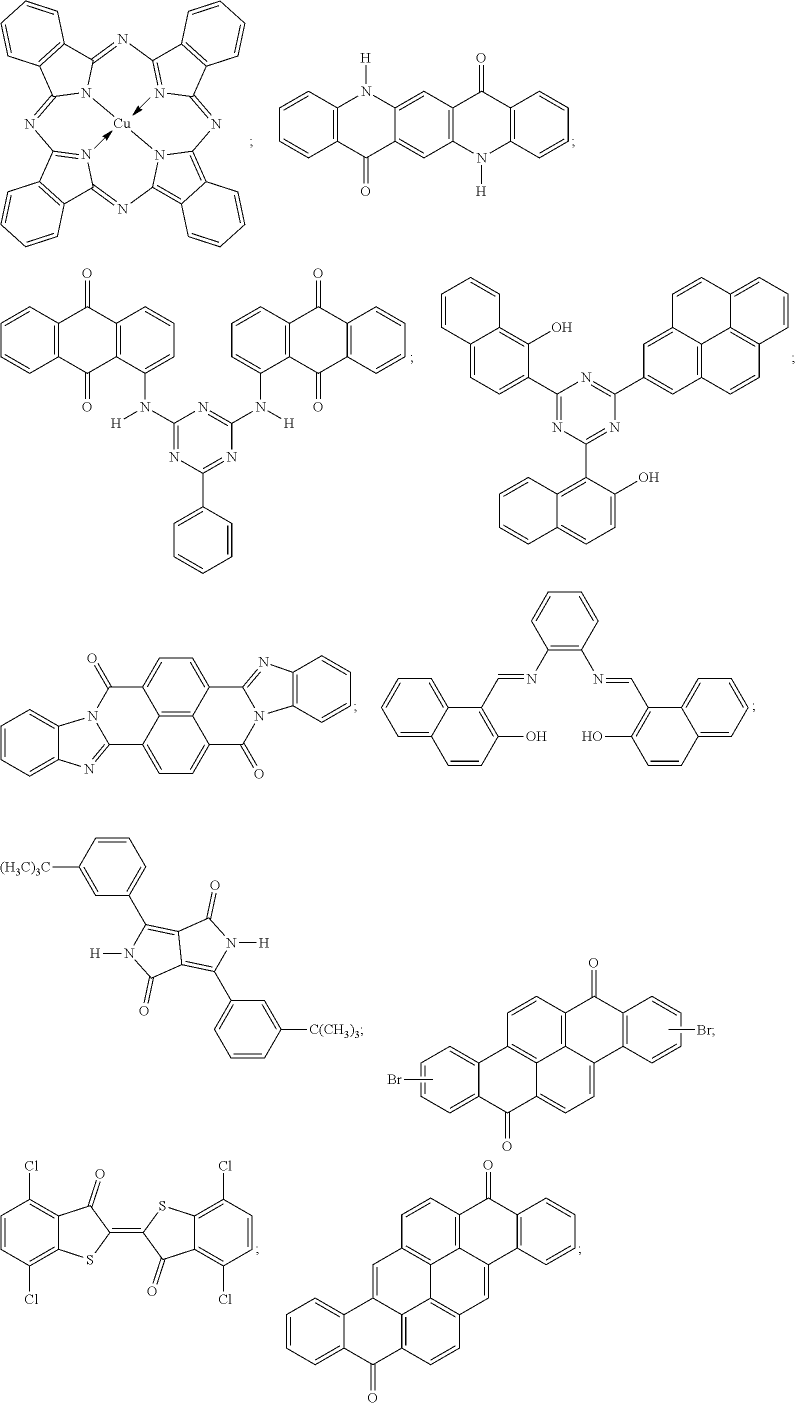

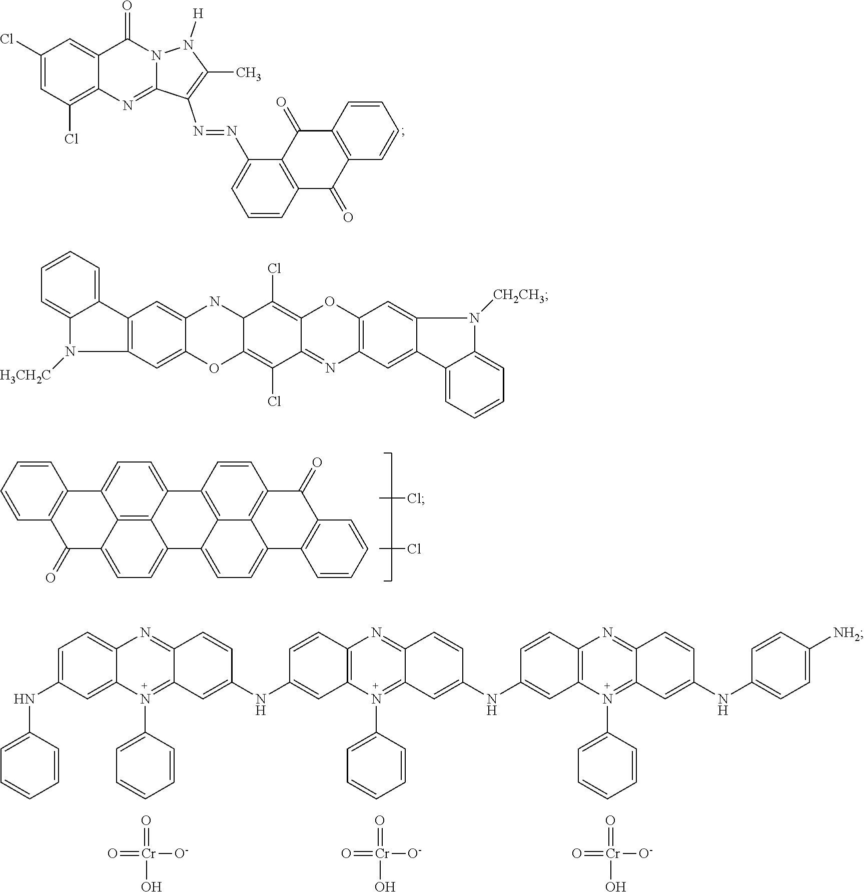

graphite; or derivatives thereof.

In some examples, the colorant is a magenta colorant. In some examples, the magenta colorant comprises a quinacrodine, anthraquinone, antharone, diketopyrrolopyrole, perylene, perinone, phthalein, pyranthrone, thioindigoid, pyrazoloquinazolone, heterocyclic compound, benzimidazolone, rhodamine, or a indanthrone. In some examples, the magenta colorant comprises a pigment selected from pigment violet 19, pigment red 177 (C.I. 65300), pigment red 168 (C.I. 59300), pigment red 272 (C.I. 561150), pigment red 179 (C.I. 71130), pigment red 194 (C.I. 71100), pigment red 174 (C.I. 45410:2), pigment red 216 (C.I. 59710), pigment red 88 (C.I. 73312), pigment red 251 (C.I. 12925), pigment red 257 (C.I. 562700), pigment red 208 (C.I. 12514), pigment red 255 (C.I. 561050), pigment red 271 (C.I. 487100), pigment orange 68 (C.I. 486150), pigment red 122, pigment red 202, pigment red 206, pigment red 207, pigment red 209, pigment red 8, pigment red 81:1, pigment red 81:2, pigment red 81:3, pigment red 81:4, pigment red 81:5, pigment red 169, pigment violet 1, pigment violet 1:1, pigment violet 2, pigment violet 2:1, pigment violet 2:2, or combinations thereof.

In some examples, the colorant is a cyan colorant. In some examples the cyan colorant comprises an isoviolanthrone, a thioindigoid, a rhodamine, or a phthalocyanin, for example

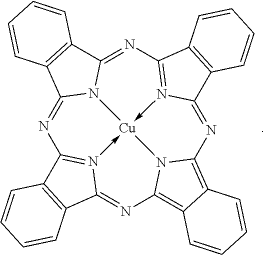

Examples of cyan colorants comprising a phthalocyanin include pigments selected from pigment blue 15:1, pigment blue 15:2, pigment blue 15:3, pigment blue 15:4, pigment blue 15:6, pigment blue 16, pigment blue 17, pigment blue 75, pigment blue 79, pigment green 7, pigment green 13, pigment green 36, pigment blue 76, pigment green 48. In some examples, the colorant comprising a phthalocyanin may comprise pigment blue 15:3. In some examples, the colorant comprising a phthalocyanin may comprise pigment blue 15:3 and pigment green 7.

An example of a cyan colorant comprising an isoviolanthrone is pigment violet 31. An example of a cyan colorant comprising a thioindigoid is pigment blue 63.

An example of a colorant comprising a rhodamine-based pigment is pigment violet 3.

In some examples, the colorant is a black colorant. In some examples the black colorant comprises carbon black, for example the black colorant may comprise graphite. Examples of black colorants are pigment black 1 (azine chemistry), pigment black 6 (a carbon black), pigment black 31 and pigment black 32.

In some examples, the colorant is an acidic colorant, e.g. an acidic pigment. An acidic pigment may be defined as a pigment that, when in water at 20° C., has a pH value of less than 7, in some examples less than 6, in some examples less than 5, in some examples less than 4, in some examples less than 3. An acidic colorant, for example, an acidic pigment, may be defined as a particulate pigment that has acidic groups (for example a carboxylic acid group, sulfonic acid group or any Lewis acid) on the surface of the particles of the pigment. In some examples, the colorant may comprise colorant particles comprising a pigment and a resin (in addition to the polymers described herein), wherein the resin comprises acidic groups and forms the surface of the colorant particles. In some examples, an acidic colorant comprises particles comprising a pigment and a compound, for example, a resin (in addition to the polymers described herein) containing acidic groups. In some examples, the colorant is a mildly acidic colorant, for example a colorant having a pH, when in water at 20° C., in the range of about 3 to less than about 7, about 4 to less than about 7, about 5 to less than about 7, or about 6 to less than about 7. Methods of determining the pH of a substance are well known to the skilled person, for example the method described in ISO Standard 31-8 Annex C. pH may be measured in water at 20° C. In some examples, the total acid number of an acidic colorant may be determined by measuring the number of acid groups neutralized by titration with an alkali.

The colorant or pigment particle may be present in the LEP ink composition in an amount of from about 10 wt % to about 80 wt % by total weight solids of the LEP ink, in some examples about 10 wt % to about 60 wt %, in some examples about 10 wt % to about 50 wt %, in some examples about 10 wt % to about 40 wt %, in some examples about 10 wt % to about 30 wt %, in some examples about 5 wt % to about 30 wt %, in some examples, 5 wt % to 20 wt %, in some examples, 5 wt % to 15 wt %, in some examples, 5 wt. % to 14 wt. %, in some examples, 11 wt. % to 13 wt. %, in some examples, 12 wt. % to 13 wt. %, in some examples, 10 wt % to 15 wt % by total weight solids of the LEP ink. In some examples, the colorant or pigment particle may be present in the LEP ink in an amount of at least about 5 wt % by total weight solids of the LEP ink, for example at least about 10 wt % total weight solids of the LEP ink.

### Amine-Containing Basic Dispersant

The LEP ink composition may comprise an amine-containing basic dispersant having a total base number (TBN) greater than about 300 mgKOH/g material. The amine-containing basic dispersant may be present in the LEP ink composition in an amount of up to about 10 wt. % by weight of the colorant. The amine-containing basic dispersant having a TBN greater than about 300 mgKOH/g material may be termed an amine-containing dispersant or a basic dispersant herein.

The basic dispersant may be a basic polymeric dispersant. In some examples, the basic polymeric dispersant comprises a basic anchor group, that is, an amine group. In some examples, each basic polymeric dispersant molecule comprises a multi amine anchor group or a single amine anchor group, in some examples each basic polymeric dispersant molecule comprises a multi amine anchor group. In some examples, the basic polymeric dispersant comprises a polyester. In some examples, the basic polymeric dispersant comprises a polyester and an amine anchor group. In some examples, the basic polymeric dispersant comprises a polyester terminated by an amine containing group bound to the polyester through an amide linkage.

In some examples, the amine-containing basic dispersant is a polyolefin amide alkeneamine.

In some examples, the basic polymeric dispersant comprises a co-polymer. In some examples, the basic polymeric dispersant comprises a block co-polymer having multiple anchor groups, for example an ABA block co-polymer or a BAB block co-polymer or a random copolymer. In some examples, the polymeric dispersant comprises a comb co-polymer.

In some examples, the amine-containing basic dispersant is Solplus P6000 (available from Lubrizol), which has a TBN of about 400 mgKOH/g material.

In some examples, the amine-containing basic dispersant has a total base number (TBN) of at least about 300 mgKOH/g material, in some examples, a TBN of at least about 310 mgKOH/g material, in some examples, a TBN of at least about 320 mgKOH/g material, in some examples, a TBN of at least about 330 mgKOH/g material, in some examples, a TBN of at least about 340 mgKOH/g material, in some examples, 350 mgKOH/g material, in some examples a TBN of at least about 360 mgKOH/g material, in some examples a TBN of at least about 370 mgKOH/g material, in some examples a TBN of at least about 380 mgKOH/g material, in some examples a TBN of at least about 390 mgKOH/g material, in some examples a TBN of about 400 mgKOH/g material. In some examples, amine-containing basic dispersant has a TBN of about 450 mgKOH/g material or less, in some examples a TBN of about 440 mgKOH/g material or less, in some examples a TBN of about 430 mgKOH/g material or less, in some examples a TBN of about 420 mgKOH/g material or less, in some examples a TBN of about 410 mgKOH/g material or less. In some examples the basic dispersant has a total base number (TBN) of from about 300 mgKOH/g material to about 450 mgKOH/g material, in some examples from about 310 mgKOH/g material to about 445 mgKOH/g material, in some examples from about 320 mgKOH/g material to about 440 mgKOH/g material, in some examples from about 330 mgKOH/g material to about 435 mgKOH/g material, in some examples from about 340 mgKOH/g material to about 430 mgKOH/g material, in some examples from about 350 mgKOH/g material to about 425 mgKOH/g material, in some examples from about 355 mgKOH/g material to about 420 mgKOH/g material, in some examples from about 360 mgKOH/g material to about 415 mgKOH/g material, in some examples from about 365 mgKOH/g material to about 410 mgKOH/g material, in some examples from about 370 mgKOH/g material to about 405 mgKOH/g material, in some examples from about 375 mgKOH/g material to about 405 mgKOH/g material, in some examples from about 380 mgKOH/g material to about 400 mgKOH/g material, in some examples from about 385 mgKOH/g material to about 450 mgKOH/g material, in some examples from about 390 mgKOH/g material to about 445 mgKOH/g material, in some examples from about 395 mgKOH/g material to about 405 mgKOH/g material.

In some examples, the amine-containing basic dispersant has a total base number (TBN) of from about 300 mgKOH/g material to about 500 mgKOH/g material, in some examples from about 380 mgKOH/g material to about 420 mgKOH/g material, in some examples about 400 mgKOH/g material.

In some examples, the amine-containing basic dispersant has a total base number (TBN) of less than about 500 mgKOH/g material, in some examples less than about 450 mgKOH/g material, in some examples less than about 425 mgKOH/g material, in some examples less than about 420 mgKOH/g material, in some examples less than about 410 mgKOH/g material.

Total base number (TBN), sometimes simply referred to as base number, may be determined using standard techniques, including, those laid out in ASTM Designation D4739-08, such as Test Method D2896, Test Method D4739, and ASTM Designation D974-08, with Test Method D2896 being used if any discrepancy is shown between test methods, and unless otherwise stated, the test method(s) will be the most recently published at the time of filing this patent application. “mgKOH/g material” indicates “mgKOH per gram of dispersant”. The measurement of TBN of the dispersant can either be on the pure dispersant, or a dispersant in water or a hydrocarbon liquid, such as 60 wt % dispersant in white spirit, e.g. dearomatized white spirit, mineral oil or distillate (e.g. C₁₀₋₂₀ hydrocarbons), and then adjusted as if it had been measured on the pure dispersant.

In some examples, the dispersant has a weight average molecular weight (MW) of about 2 kg/mol or more, for example, about 2.1 kg/mol or more, about 2.2 kg/mol or more, about 2.3 kg/mol or more, about 2.4 kg/mol or more, about 2.5 kg/mol or more, about 2.6 kg/mol or more, about 2.7 kg/mol or more, about 2.8 kg/mol or more, about 2.9 kg/mol or more, or about 3 kg/mol. In some examples, the dispersant has a weight average molecular weight (WW) of about 5 kg/mol or less, for example, about 4.9 kg/mol or less, about 4.8 kg/mol or less, about 4.7 kg/mol or less, about 4.6 kg/mol or less, about 4.5 kg/mol or less, about 4.4 kg/mol or less, about 4.3 kg/mol or less, about 4.2 kg/mol or less, about 4.1 kg/mol or less, or about 4 kg/mol. In some examples, the dispersant has a weight average molecular weight (MW) of from about 2 kg/mol to about 5 kg/mol, for example, from about 2.1 kg/mol to about 4.9 kg/mol, from about 2.2 kg/mol to about 4.8 kg/mol, from about 2.3 kg/mol to about 4.7 kg/mol, from about 2.4 kg/mol to about 4.6 kg/mol, from about 2.5 kg/mol to about 4.5 kg/mol, from about 2.6 kg/mol to about 4.4 kg/mol, from about 2.7 kg/mol to about 4.3 kg/mol, from about 2.8 kg/mol to about 4.2 kg/mol, from about 2.9 kg/mol to about 4.1 kg/mol, or from about 3 kg/mol to about 4 kg/mol. In some examples, the dispersant may have a weight average molecular weight of about 3.5 kg/mol.

In some examples, the LEP ink composition comprises an amine-containing basic dispersant in an amount up to about 10 wt. % by weight of the colorant, for examples up to about 9 wt. %, up to about 8 wt. %, up to about 7 wt. %, up to about 6 wt. %, up to about 5 wt. %, up to about 4.5 wt. %, up to about 4 wt. % by weight of the colorant.

In some examples, the LEP ink composition comprises an amine-containing basic dispersant in an amount of at least about 0.01 wt. % by weight of the colorant, for example at least about 0.1 wt. %, at least about 0.2 wt. %, at least about 0.3 wt. %, at least about 0.4 wt. %, at least about 0.5 wt. %, at least about 0.6 wt. %, at least about 0.7 wt. %, at least about 0.75 wt. %, at least about 0.8 wt. %, at least about 0.9 wt. %, at least about 1.1 wt. %, at least about 1.2 wt. %, at least about 1.3 wt. %, at least about 1.4 wt. %, or at least about 1.5 wt. % by weight of the colorant.

In some examples, the LEP ink composition comprises an amine-containing basic dispersant in an amount in the range of about 0.01 wt. % to about 10 wt. % by weight of the colorant, for example, about 0.1 wt. % to about 10 wt. %, about 0.1 wt. % to about 5 wt. %, about 0.5 wt. % to about 10 wt. %, about 0.5 wt. % to about 8 wt. %, about 0.5 wt. % to about 6 wt. %, about 0.5 wt. % to about 5 wt. %, about 0.75 wt. % to about 8 wt. %, about 1 wt. % to about 5 wt. %, about 1 wt. % to about 10 wt. %, about 1 wt. % to about 8 wt. %, about 1 wt. % to about 6 wt. % by weight of the colorant.

The amine-containing basic dispersant may constitute from 0.01 wt. % to 2 wt. % of the total solids of the electrostatic ink composition, in some examples 0.05 wt. % to 1.9 wt. % of the total solids of the electrostatic ink composition, in some examples 0.09 wt. % to 1.8 wt. % of the total solids of the electrostatic ink composition, in some examples 0.01 wt. % to 1.7 wt. % of the total solids of the electrostatic ink composition, in some examples 0.05 wt. % to 1.6 wt. % of the total solids of the electrostatic ink composition, in some examples 0.11 wt. % to 1.5 wt. % of the total solids of the electrostatic ink composition, in some examples 0.11 wt. % to 1.4 wt. % of the total solids of the electrostatic ink composition, in some examples 0.15 wt. % to 1.3 wt. % of the total solids of the electrostatic ink composition, in some examples 0.01 wt. % to 1.2 wt. % of the total solids of the electrostatic ink composition, in some examples 0.05 wt. % to 1.1 wt. % of the total solids of the electrostatic ink composition, in some examples 0.09 wt. % to 1.2 wt. % of the total solids of the electrostatic ink composition, in some examples 0.1 wt. % to 1.1 wt. % of the total solids of the electrostatic ink composition, in some examples, 0.1 wt. % to 1 wt. % of the total solids of the electrostatic ink composition, in some examples, 0.11 wt. % to 0.9 wt. % of the total solids of the electrostatic ink composition, in some examples, 0.2 wt. % to 0.8 wt. % of the total solids of the electrostatic ink composition, in some example, 0.01 wt. % to 0.7 wt. % of the total solids of the electrostatic ink composition, in some examples, 0.05 wt. % to 0.6 wt. % of the total solids of the electrostatic ink composition, in some examples, 0.09 wt. % to 0.55 wt. % of the total solids of the electrostatic ink composition, in some examples, 0.01 wt. % to 0.54 wt. % of the total solids of the electrostatic ink composition, in some examples, 0.05 wt. % to 0.5 wt. % of the total solids of the electrostatic ink composition. In some examples, the amine-containing basic dispersant may constitute up to about 2 wt. %, up to about 1.9 wt. %, up to about 1.8 wt. %, up to about 1.7 wt. %, up to about 1.6 wt. %, up to about 1.5 wt. %, up to about 1.4 wt. %, up to about 1.3 wt. %, up to about 1.2 wt. %, up to about 1.1 wt. %, up to about 1 wt. %, up to about 0.9 wt. %, up to about 0.8 wt. %, up to about 0.7 wt. %, up to about 0.6 wt. %, up to about 0.55 wt. %, up to about 0.54 wt. %, or up to about 0.5 wt. % of the total solids of the electrostatic ink composition.

### Amine-Containing Compound

The LEP ink composition may comprise an amine-containing compound having a pKa of 8 or more at 25° C. The amine-containing compound having a pKa of 8 or more at 25° C. may be termed an amine-containing compound herein.

In some examples, the amine-containing compound may have a pKa at 25° C. of 8 or more, in some examples, 8.1 or more, in some examples, 8.2 or more, in some examples, 8.3 or more, in some examples, 8.4 or more, in some examples, 8.5 or more, in some examples, 8.6 or more, in some examples, 8.7 or more, in some examples, 8.8 or more, in some examples, 8.9 or more, in some examples, 9 or more, in some examples, 9.1 or more, in some examples, 9.2 or more, in some examples, 9.3 or more, in some examples, 9.4 or more, in some examples, 9.5 or more. In some examples, the amine-containing compound may have a pKa at 25° C. of 8 to 14, in some examples, 8 to 12, in some examples, 8.1 to 11.5, in some examples, 8.2 to 11, in some examples, 8.3 to 10.5, in some examples, 8.4 to 10, in some examples, 8.5 to 9.9, in some examples, 8.6 to 9.8, in some examples, 8.7 to 9.7, in some examples, 8.8 to 9.6, in some examples, 8.9 to 9.5, in some examples, 9 to 12, in some examples, 9.1 to 10.5, in some examples, 9.2 to 10, in some examples, 9.3 to 9.5, in some examples, 9.4 to 12, in some examples, 9.5 to 14.

As used herein, the pKa is provided for the amine-containing compound in water as the solvent. As used herein, the pKa values provided are the pKa values of the conjugate acid of the amine-containing compound. Ka is the acid dissociation constant and pKa is the negative base-10 log of the acid dissociation constant. pKa values are given in a number of textbooks, for example, W. P. Jencks and J. Regenstein (1976) Ionisation constants of acids and bases, Handbook of Biochemistry and Molecular Biology (Fasman, G. D., ed.), pp. 305-351, CRC Press, Cleveland, International Union of Pure and Applied Chemistry. Further, methods of discerning the pKa for example, ones analogous to that described in ISO Standard 31-8 Annex C, are well documented in the art. Both of these references are incorporated herein by reference in their entirety.

In some examples, the amine-containing compound may have a weight average molecular weight of 1000 or less, in some examples, 500 or less, in some examples, 250 or less, in some examples, 200 or less, in some examples, 150 or less, in some examples, 100 or less, in some examples, 95 or less, in some examples, 90 or less, in some examples, or 85 less, in some examples, 80 or less, in some examples, 75 or less, in some examples, 70 or less, in some examples, 65 or less, in some examples, 60 or less, in some examples, 55 or less, in some examples, 50 or less, in some examples, 45 or less, in some examples, 40 or less. In some examples, the amine-containing compound may have a weight average molecular weight of 40 or more, in some examples, 45 or more, in some examples, 50 or more, in some examples, 55 or more, in some examples, 60 or more. In some examples, the amine-containing compound may have a weight average molecular weight of 40 to 1000, in some examples, 40 to 950, in some examples, 40 to 900, in some examples, 40 to 850, in some examples, 45 to 800, in some examples, 45 to 750, in some examples, 45 to 700, in some examples, 45 to 650, in some examples, 45 to 600, in some examples, 50 to 550, in some examples, 50 to 500, in some examples, 50 to 450, in some examples, 40 to 400, in some examples, 45 to 350, in some examples, 55 to 300, in some examples, 55 to 250, in some examples, 55 to 200, in some examples, 60 to 150, in some examples, 60 to 100, in some examples, 40 to 95, in some examples, 40 to 90, in some examples, 45 to 85, in some examples, 45 to 80, in some examples, 50 to 75, in some examples, 55 to 70, in some examples, 55 to 65, in some examples, 60 to 65.

In some examples, the amine-containing compound is an aliphatic amine-containing compound. In some examples, the amine-containing compound is a linear amine-containing compound. In some examples, the amine-containing compound is a linear aliphatic amine-containing compound. In some examples, the amine-containing compound is a primary amine, a secondary amine, a tertiary amine or an imine, for example, an aliphatic primary amine (e.g., mono ethanol amine), an aliphatic secondary amine (e.g., diisopropylamine), an aliphatic tertiary amine or an aliphatic imine (e.g., an imine, such as trimethylimine). In some examples, the amine-containing compound is selected from mono ethanol amine, diisopropylamine and trimethylimine. In some examples, the amine-containing compound is mono ethanol amine (MEA).

In some examples, the amine-containing compound comprises a nitrogen substituted with one, two or three hydrocarbon chains, wherein the hydrocarbon chains may comprise hydroxyl substituents. In some examples, the hydrocarbon chain may be a linear hydrocarbon chain or a branched hydrocarbon chain. In some examples, the hydrocarbon chain is a linear hydrocarbon chain. In some examples, the hydrocarbon chain is an aliphatic hydrocarbon chain. In some examples, the hydrocarbon chain may be substituted by one or more hydroxyl substituent. In some examples, the hydrocarbon chain is unsubstituted.

In some examples, the LEP ink composition comprises the amine-containing compound in an amount of up to about 15 wt. % by weight of the colorant, for example up to about 14 wt. %, up to about 13 wt. %, up to about 12 wt. %, up to about 11 wt. %, up to about 10 wt. %, up to about 9 wt. %, up to about 8 wt. %, up to about 7 wt. %, up to about 6 wt. %, up to about 5 wt. %, or up to about 4 wt. %.

In some examples, the LEP ink composition comprises the amine-containing compound in an amount of at least about 0.01 wt. % by weight of the colorant, for example at least about 0.05 wt. %, at least about 0.1 wt. %, at least about 0.15 wt. %, at least about 0.2 wt. %, at least about 0.3 wt. %, at least about 0.4 wt. %, at least about 0.5 wt. %, at least about 0.6 wt. %, at least about 0.7 wt. %, at least about 0.75 wt. %, or at least about 1 wt. % by weight of the colorant.

In some examples, the LEP ink composition comprises the amine-containing compound in an amount in the range of from about 0.01 wt. % to about 15 wt. % by weight of the colorant, for example from about 0.1 wt. % to about 15 wt. %, from about 0.1 wt. % to about 10 wt. %, from about 0.1 wt. % to about 5 wt. %, or from about 0.5 wt. % to about 5 wt. % by weight of the colorant.

The amine-containing compound may constitute from 0.01 wt. % to 2 wt. % of the total solids of the electrostatic ink composition, in some examples 0.05 wt. % to 1.9 wt. % of the total solids of the electrostatic ink composition, in some examples 0.09 wt. % to 1.8 wt. % of the total solids of the electrostatic ink composition, in some examples 0.1 wt. % to 1.7 wt. % of the total solids of the electrostatic ink composition, in some examples 0.05 wt. % to 1.6 wt. % of the total solids of the electrostatic ink composition, in some examples 0.15 wt. % to 1.5 wt. % of the total solids of the electrostatic ink composition, in some examples 0.11 wt. % to 1.4 wt. % of the total solids of the electrostatic ink composition, in some examples 0.2 wt. % to 1.3 wt. % of the total solids of the electrostatic ink composition, in some examples 0.07 wt. % to 1.2 wt. % of the total solids of the electrostatic ink composition, in some examples 0.05 wt. % to 1.1 wt. % of the total solids of the electrostatic ink composition, in some examples 0.09 wt. % to 1 wt. % of the total solids of the electrostatic ink composition, in some examples, 0.11 wt. % to 0.9 wt. % of the total solids of the electrostatic ink composition, in some examples, 0.2 wt. % to 0.8 wt. % of the total solids of the electrostatic ink composition, in some example, 0.01 wt. % to 0.7 wt. % of the total solids of the electrostatic ink composition, in some examples, 0.05 wt. % to 0.6 wt. % of the total solids of the electrostatic ink composition in some examples, 0.05 wt. % to 0.5 wt. % of the total solids of the electrostatic ink composition, in some examples 0.1 wt. % to 0.4 wt. % of the total solids of the electrostatic ink composition, in some examples 0.05 wt. % to 0.3 wt. % of the total solids of the electrostatic ink composition, in some examples, 0.01 wt. % to 0.25 wt. % of the total solids of the electrostatic ink composition. In some examples, the amine containing compound may constitute up to about up to about 2 wt. %, up to about 1.9 wt. %, up to about 1.8 wt. %, up to about 1.7 wt. %, up to about 1.6 wt. %, up to about 1.5 wt. %, up to about 1.4 wt. %, up to about 1.3 wt. %, up to about 1.2 wt. %, up to about 1.1 wt. %, up to about 1 wt. %, up to about 0.9 wt. %, up to about 0.8 wt. %, up to about 0.7 wt. %, up to about 0.6 wt. %, up to about 0.5 wt. %, up to about 0.44 wt. %, up to about 0.43 wt. % or up to about 0.4 wt. % of the total solids of the electrostatic ink composition.

Urea

In some examples, the LEP ink composition may comprise urea.

In some examples, the LEP ink composition comprises urea in an amount of up to about 20 wt. % by weight of the colorant, for example, up to about 18 wt. %, up to about 16 wt. %, up to about 15 wt. %, up to about 14 wt. %, up to about 12 wt. %, up to about 10 wt. % by weight of the colorant.

In some examples, the LEP ink composition comprises urea in an amount of at least about 0.01 wt. % by weight of the colorant, for example at least about 0.05 wt. %, at least about 0.15 wt. %, at least about 0.2 wt. %, at least about 0.3 wt. %, at least about 0.4 wt. %, at least about 0.5 wt. %, at least about 0.6 wt. %, at least about 0.7 wt. %, at least about 0.75 wt. %, at least about 1 wt. %, at least about 1.2 wt. %, at least about 1.5 wt. %, at least about 1.8 wt. %, at least about 2 wt. %, at least about 2.1 wt. %, at least about 2.2 wt. %, at least about 2.3 wt. %, at least about 2.4 wt. %, at least about 2.5 wt. %, at least about 2.6 wt. %, at least about 2.7 wt. %, at least about 2.8 wt. %, at least about 2.9 wt. %, or at least about 3 wt. % by weight of the colorant.

In some examples, the LEP ink composition comprises urea in an amount in the range of from about 0.1 wt. % to about 20 wt. % by weight of the colorant, for example from about 1 wt. % to about 20 wt. %, from about 1 wt. % to about 15 wt. %, or from about 1 wt. % to about 10 wt. % by weight of the colorant.

Urea may constitute from to 0.01 wt. % to 2 wt. % of the total solids of the electrostatic ink composition, in some examples 0.05 wt. % to 1.9 wt. % of the total solids of the electrostatic ink composition, in some examples 0.09 wt. % to 1.8 wt. % of the total solids of the electrostatic ink composition, in some examples 0.1 wt. % to 1.7 wt. % of the total solids of the electrostatic ink composition, in some examples 0.11 wt. % to 1.6 wt. % of the total solids of the electrostatic ink composition, in some examples 0.2 wt. % to 1.5 wt. % of the total solids of the electrostatic ink composition, in some examples 0.5 wt. % to 1.4 wt. % of the total solids of the electrostatic ink composition, in some examples 0.6 wt. % to 1.3 wt. % of the total solids of the electrostatic ink composition, in some examples 1 wt. % to 1.2 wt. % of the total solids of the electrostatic ink composition, in some examples 0.05 wt. % to 1.1 wt. % of the total solids of the electrostatic ink composition. In some examples, urea may constitute up to about 2 wt. %, up to about 1.9 wt. %, up to about 1.8 wt. %, up to about 1.7 wt. %, up to about 1.6 wt. %, up to about 1.5 wt. %, up to about 1.4 wt. %, up to about 1.3 wt. %, up to about 1.2 wt. %, up to about 1.1 wt. % of the total solids of the electrostatic ink composition.

### Hydrocarbon Carrier Liquid

The electrostatic ink composition may include a hydrocarbon carrier liquid. In some examples, the electrostatic ink composition comprises ink particles including the resin that may be dispersed in the liquid carrier. The liquid carrier comprises a hydrocarbon. The liquid carrier can include, for example, an insulating, non-polar, non-aqueous liquid that can be used as a medium for ink particles, i.e. the ink particles including the resin and a colorant, in some examples the resin, a colorant and a component selected from an amine-containing dispersant, an amine-containing compound or urea. The liquid carrier can include compounds that have a resistivity in excess of about 10⁹ ohm·cm. The liquid carrier may have a dielectric constant below about 5, in some examples below about 3. The liquid carrier can include more than one hydrocarbon. The hydrocarbon can include, for example, an aliphatic hydrocarbon, an isomerized aliphatic hydrocarbon, branched chain aliphatic hydrocarbons, aromatic hydrocarbons, and combinations thereof. Examples of the liquid carriers include, for example, aliphatic hydrocarbons, isoparaffinic compounds, paraffinic compounds, dearomatized hydrocarbon compounds, and the like. In particular, the liquid carriers can include, for example, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™ Nisseki Naphthesol H™, #0 Solvent L™, #0 Solvent M™, #0 Solvent H™, Nisseki Isosol 300™, Nisseki Isosol 400™, AF-4™, AF-S™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

The liquid carrier can constitute about 20% to 99.5% by weight of the electrostatic ink composition, in some examples 50% to 99.5% by weight of the electrostatic ink composition. The liquid carrier may constitute about 40 to 90% by weight of the electrostatic ink composition. The liquid carrier may constitute about 60% to 80% by weight of the electrostatic ink composition. The liquid carrier may constitute about 90% to 99.5% by weight of the electrostatic ink composition, in some examples 95% to 99% by weight of the electrostatic ink composition.

The electrostatic ink composition, when printed on a print substrate, may be substantially free from liquid carrier. In an electrostatic printing process and/or afterwards, the liquid carrier may be removed, e.g. by an electrophoresis processes during printing and/or evaporation, such that substantially just solids are transferred to the print substrate. Substantially free from liquid carrier may indicate that the ink printed on the print substrate contains less than 5 wt. % liquid carrier, in some examples, less than 2 wt. % liquid carrier, in some examples less than 1 wt. % liquid carrier, in some examples less than 0.5 wt. % liquid carrier. In some examples, the ink printed on the print substrate is free from liquid carrier.

### Resin

The LEP ink composition may include a resin. For example the LEP ink composition may comprise ink particles comprising a resin and a colorant. In some examples, the ink particles comprise a resin, a colorant and a component selected from an amine-containing basic dispersant, an amine-containing compound or urea.

The ink particles may be chargeable particles, i.e. having or capable of developing a charge, for example in an electromagnetic field. The resin may be a thermoplastic resin. A thermoplastic polymer is sometimes referred to as a thermoplastic resin. The ink particles may be formed by combining the colorant and a component selected from an amine-containing basic dispersant, an amine-containing compound and urea, for example by grinding, for example to provide colorant particles comprising the colorant and a component selected from an amine-containing basic dispersant, an amine-containing compound and urea. The colorant particles may then be combined with a resin, for example by grinding, to provide ink particles. The resin may coat the colorant, or colorant particles comprising the colorant and the component selected from an amine-containing basic dispersant, an amine-containing compound and urea. The particles may include a core of colorant or colorant particles and have an outer layer of resin thereon. The colorant or colorant particles may be dispersed throughout each resin-containing particle. The outer layer of resin may coat the colorant or colorant particle partially or completely.

The resin typically includes a polymer. The resin can include, but is not limited to, a thermoplastic polymer. In some examples, the polymer of the resin may be selected from ethylene acrylic acid copolymers; ethylene methacrylic acid copolymers; ethylene vinyl acetate copolymers; copolymers of ethylene (e.g. 80 wt % to 99.9 wt %), and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt % to about 25 wt % of the copolymer, in some examples from 10 wt % to about 20 wt % of the copolymer.

The resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the resin may comprise a copolymer of ethylene and a monomer selected from methacrylic acid and acrylic acid.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a co-polymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), an example of the second polymer is Nucrel 699 (from DuPont), and an example of the third polymer is AC-5120 (from Honeywell). In some examples, the resin may comprise a first polymer having a melt viscosity of from 15000 poise to 40000 poise, in some examples 20000 poise to 30000 poise, and a second polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 699 (from DuPont), and an example of the second polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, in some examples 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, in some examples from 14 wt % to about 20 wt % of the copolymer, in some examples from 16 wt % to about 20 wt % of the copolymer in some examples from 17 wt % to 19 wt % of the copolymer.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40 by weight of the total solids of the electrostatic ink composition. In another example, the resin constitutes about 60 to 95% by weight, in some examples from 80 to 90% by weight, of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the co-polymer, in some examples 5 to 40% by weight, in some examples 5 to 20% by weight of the copolymer, in some examples 5 to 15% by weight of the copolymer. The second monomer may constitute 1 to 50% by weight of the co-polymer, in some examples 5 to 40% by weight of the co-polymer, in some examples 5 to 20% by weight of the co-polymer, in some examples 5 to 15% by weight of the copolymer. In an example, the first monomer constitutes 5 to 40% by weight of the co-polymer, the second monomer constitutes 5 to 40% by weight of the co-polymer, and with the third monomer constituting the remaining weight of the copolymer. In an example, the first monomer constitutes 5 to 15% by weight of the co-polymer, the second monomer constitutes 5 to 15% by weight of the co-polymer, with the third monomer constituting the remaining weight of the copolymer. In an example, the first monomer constitutes 8 to 12% by weight of the co-polymer, the second monomer constitutes 8 to 12% by weight of the co-polymer, with the third monomer constituting the remaining weight of the copolymer. In an example, the first monomer constitutes about 10 by weight of the co-polymer, the second monomer constitutes about 10% by weight of the co-polymer, and with the third monomer constituting the remaining weight of the copolymer. The polymer having ester side groups may be selected from the Bynel class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), AC-5120 (sold by Honeywell), and the Lotader family of toners (e.g. Lotader 2210, Lotader, 3430, and Lotader 8200 (sold by Arkema)).

In some examples, the resin may constitute 5% to 99% by weight of the total solids in the electrostatic ink composition, in some examples 50% to 90% by weight of the total solids of the electrostatic ink composition, in some examples 70% to 90% by weight of the total solids of the electrostatic ink composition.

### Charge Director

In some examples, the electrostatic ink composition includes a charge director. The charge director may be added to an electrostatic ink composition in order to impart and/or maintain sufficient electrostatic charge on the ink particles. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of an electrostatic ink composition.

The charge director may be added in order to impart and/or maintain sufficient electrostatic charge on the ink particles, which may be particles comprising the thermoplastic resin.

In some examples, the electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cr, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂TiO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

In some examples, the electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃⁻)C(O)—O—R²], wherein each of R¹ and R² is an alkyl group. In some examples each of R¹ and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20% by weight, in some examples 0.01% to 20% by weight, in some examples 0.01 to 10% by weight, in some examples 0.01% to 5% by weight of the total solids of an electrostatic ink composition. In some examples, the charge director constitutes about 1% to 4% by weight of the total solids of the electrostatic ink composition, in some examples 2% to 4 by weight of the total solids of the electrostatic ink composition.

In some examples, the charge director is present in an amount sufficient to achieve a particle conductivity of 200 pmho/cm or less, in some examples, 190 pmho/cm or less, in some examples, 180 pmho/cm or less, in some examples, 170 pmho/cm or less, in some examples, 160 pmho/cm or less, in some examples, 150 pmho/cm or less, in some examples, 140 pmho/cm or less, in some examples, 130 pmho/cm or less, in some examples, 120 pmho/cm or less, in some examples, 110 pmho/cm or less, in some examples, about 100 pmho/cm. In some examples, the charge director is present in an amount sufficient to achieve a particle conductivity of 50 pmho/cm or more, in some examples, 60 pmho/cm or more, in some examples, 70 pmho/cm or more, in some examples, 80 pmho/cm or more, in some examples, 90 pmho/cm or more, in some examples, about 100 pmho/cm. In some examples, the charge director is present in an amount sufficient to achieve a particle conductivity of 50 pmho/cm to 200 pmho/cm, in some examples, 60 pmho/cm to 190 pmho/cm, in some examples, 50 pmho/cm to 180 pmho/cm, in some examples, 60 pmho/cm to 170 pmho/cm, in some examples, 70 pmho/cm to 160 pmho/cm, in some examples, 80 pmho/cm to 150 pmho/cm, in some examples, 70 pmho/cm to 140 pmho/cm, in some examples, 80 pmho/cm to 130 pmho/cm, in some examples, 90 pmho/cm to 120 pmho/cm, in some examples, 90 pmho/cm to 110 pmho/cm, in some examples, 100 pmho/cm to 110 pmho/cm, in some examples, 90 pmho/cm to 100 pmho/cm.

In some examples, the charge director is present in an amount of from 3 mg/g to 50 mg/g, in some examples from 3 mg/g to 45 mg/g, in some examples from 10 mg/g to 40 mg/g, in some examples from 5 mg/g to 35 mg/g, in some examples, 20 mg/g to 35 mg/g, in some examples, 22 mg/g to 34 mg/g (where mg/g indicates mg per gram of solids of the electrostatic ink composition).

### Other Additives

The electrostatic ink composition may include another additive or a plurality of other additives. The other additive or plurality of other additives may be added at any stage of the method. The other additive or plurality of other additives may be selected from a charge adjuvant, a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket. In some examples, the LEP ink composition comprises silica, which may be added, for example, to improve the durability of images produced using the LEP ink. The other additives may constitute 10 wt % or less of the total solids of the electrostatic ink composition, in some examples 5 wt % or less of the total solids of the electrostatic ink composition, in some examples 3 wt % or less of the total solids of the electrostatic ink composition.

In some examples, the electrostatic ink composition includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), or hydroxy bis(3,5-di-tert-butyl salicylic) aluminate monohydrate. In an example, the charge adjuvant is or includes aluminum di- or tristearate. In some examples, the charge adjuvant is VCA (aluminium stearate and aluminium palmitate, available from Sigma Aldrich).

The charge adjuvant may be present in an amount of about 0.1 to 5% by weight, in some examples about 0.1 to 1% by weight, in some examples about 0.3 to 0.8 by weight of the total solids of the electrostatic ink composition, in some examples, about 1 wt % to 5 wt % of the total solids of the electrostatic ink, in some examples about 1 wt % to 3 wt % of the total solids of the electrostatic ink composition, in some examples about 1.5 wt % to 2.5 wt % of the total solids of the electrostatic ink composition.

The charge adjuvant may be present in an amount of less than 5% by weight of total solids of the electrostatic ink composition, in some examples in an amount of less than 4.5% by weight, in some examples in an amount of less than 4% by weight, in some examples in an amount of less than 3.5% by weight, in some examples in an amount of less than 3% by weight, in some examples in an amount of less than 2.5% by weight of the total solids of the electrostatic ink composition.

In some examples, the electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C₈ to C₂₆ fatty acid anion, in some examples a C₁₄ to C₂₂ fatty acid anion, in some examples a C₁₆ to C₂₀ fatty acid anion, in some examples a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt % to 5 wt % of the total solids of the electrostatic ink composition, in some examples in an amount of 0.1 wt % to 3 wt % of the total solids of the electrostatic ink composition, in some examples about 1 wt % to 3 wt % of the total solids of the electrostatic ink composition, in some examples about 1.5 wt % to 2.5 wt % of the total solids of the electrostatic ink composition.

### Method of Producing a LEP Ink Composition

The method of producing a LEP ink composition may comprise combining a hydrocarbon carrier liquid, a resin, a colorant comprising a conjugated compound, and a component selected from an amine-containing basic dispersant, an amine-containing compound or urea.

In some examples, the method comprises combining the colorant and the component selected from an amine-containing basic dispersant, an amine-containing compound or urea, e.g. to form colorant particles, before adding the resin to the combined colorant and component selected from an amine-containing basic dispersant, an amine-containing compound or urea.

In some examples, the method comprises combining the colorant and the amine-containing basic dispersant, e.g., to form colorant particles, before adding the resin to the combined colorant and amine-containing basic dispersant.

In some examples, the method comprises combining the colorant and the amine-containing compound, e.g., to form colorant particles, before adding the resin to the combined colorant and amine-containing compound.

In some examples, the method comprises combining the colorant and urea, e.g., to form colorant particles, before adding the resin to the combined colorant and urea.

In some examples, the method comprises combining the colorant and the component selected from an amine-containing basic dispersant, an amine-containing compound and urea to form colorant particles before combining the colorant particles and the resin.

In some examples, combining the colorant and the component selected from an amine-containing basic dispersant, an amine-containing compound or urea comprises grinding the colorant and the component selected from an amine-containing basic dispersant, an amine-containing compound and urea.

In some examples, the amine-containing basic dispersant is a liquid and is combined with the colorant to form a slurry before addition of the resin. In some examples, the amine-containing basic dispersant is a liquid and is ground with the colorant to form a slurry before addition of the resin, which may be followed by further grinding. In some examples, the amine-containing compound is a liquid and is combined with the colorant to form a slurry before addition of the resin. In some examples, the amine-containing compound is a liquid and is ground with the colorant to form a slurry before addition of the resin, which may be followed by further grinding.

In some examples, the amine-containing basic dispersant is a solid and is ground with the colorant and the resin (e.g., without first combining the amine-containing basic dispersant with the colorant). In some examples, the amine-containing compound is a solid and is ground with the colorant and the resin (e.g., without first combining the amine-containing compound with the colorant). In some examples, urea is ground with the colorant and the resin (e.g., without first combining urea with the colorant).

In some examples, the method comprises adding a charge director to the electrostatic ink composition.

In some examples, the method comprises adding a charge adjuvant to the electrostatic ink composition. The charge adjuvant may be added to the electrostatic ink composition before, during or after the colorant, the component selected from an amine-containing basic dispersant, an amine-containing compound or urea and the resin are combined.

In some examples, the method comprises combining a component selected from an amine-containing basic dispersant, an amine-containing compound or urea and the colorant in a ratio of about 0.01:99.99 to about 20:80, for example, about 0.1:99.9 to about 15:85, about 0.5:99.5 to about 13:87, about 1:99 to about 10:90, about 0.05:99.95 to about 8:92, about 0.75:99.25 to about 7:93, about 0.5:99.5 to about 6:94, about 0.01:99.99 to about 5:95.

In some examples, the method comprises combining the amine-containing basic dispersant and the colorant in a ratio of about 0.01:99.99 to about 10:90, for example, about 0.1:99.9 to about 10:90, about 0.1:99.9 to about 5:95, about 0.5:99.5 to about 10:90, about 0.5:99.5 to about 8:92, about 0.5:99.5 to about 6:94, about 0.5:99.5 to about 5:95, about 0.75:99.25 to about 8:92, about 1:99 to about 5:95, about 1:99 to about 10:90, about 1:99 to about 8:92, about 1:99 to about 7:93.

In some examples, the method comprises combining the amine-containing compound and the colorant in a ratio of about 0.01:99.99 to about 15:85, for example, about 0.1:99.9 to about 15:85, about 0.1:99.9 to about 10:90, about 0.1:99.9 to about 5:95, about 0.5:99.5 to about 5:95.

In some examples, the method comprises combining urea and the colorant in a ratio of about 0.1:99.9 to about 20:80, for example, about 1:99 to about 20:80, about 1:99 to about 1:15, about 1:99 to about 1:10.

In some examples, the method comprises combining the colorant and a component selected from an amine-containing basic dispersant, an amine-containing compound or urea with a resin in a colorant and component selected from an amine-containing basic dispersant, an amine-containing compound or urea to resin ratio of about 5:95 to about 30:70, for example about 10:90 to about 20:80, about 12:88 to about 18:82, about 14:86 to about 16:84.

### Method of Printing an LEP Ink Composition

In an aspect, there is provided a method of printing an LEP ink composition, the method comprising providing an LEP ink composition comprising: a hydrocarbon carrier; a resin; a colorant; and a component selected from an amine-containing basic dispersant, an amine containing compound or urea; and liquid electrostatically printing the LEP ink composition onto a substrate.

The LEP ink composition may be as described above.

In some examples, the method of printing an LEP ink composition may comprise printing a plurality of different LEP ink compositions to form an image on a print substrate, at least one of which comprises an LEP ink composition as described above. In some examples, the method of printing an LEP ink composition may comprise printing a cyan LEP ink composition, wherein the cyan ink composition comprises an LEP ink composition as described above. In some examples, the method of printing an LEP ink composition may comprise printing a magenta LEP ink composition, wherein the magenta ink composition comprises an LEP ink composition as described above. In some examples, the method of printing an LEP ink composition may comprise printing a black LEP ink composition, wherein the black ink composition comprises an LEP ink composition as described above. In some examples, the method of printing an LEP ink composition may comprise printing a cyan LEP ink composition, a magenta LEP ink composition and a black LEP ink composition, wherein at least one of the cyan LEP ink composition, the magenta LEP ink composition and the black ink composition comprises an LEP ink composition as described above. In some examples, the method of LEP printing may also comprise printing a yellow LEP ink composition.

In some examples, liquid electrostatically printing the LEP ink composition onto a substrate may comprise contacting the LEP ink composition with a latent electrostatic image on a surface to create a developed image and transferring the developed image to a substrate, in some examples, via an intermediate transfer member.

In some examples, the surface on which the (latent) electrostatic image is formed or developed may be on a rotating member, e.g., in the form of a cylinder. The surface on which the (latent) electrostatic image is formed or developed may form a part of a photo imaging plate (PIP). The method may involve passing the LEP ink composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, e.g., to a temperature of from 80 to 160° C.

The substrate may be any suitable substrate. The substrate may be any suitable substrate capable of having an image printed thereon. The substrate may include a material selected from an organic or inorganic material. The material may include a natural polymeric material, e.g., cellulose. The material may include a synthetic polymeric material, e.g., a polymer formed from alkylene monomers, including, for example, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g., a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print. In some examples, a primer may be coated onto the print substrate, before the liquid electrostatic ink composition is printed onto the print substrate.

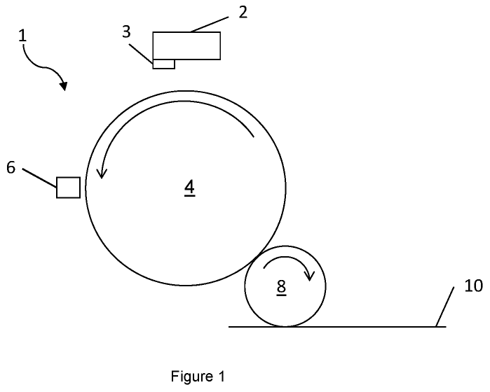

FIG. 1 shows a schematic illustration of a liquid electrophotographic (LEP) printing apparatus which may be used to liquid electrostatically print a liquid electrophotographic ink composition as described herein. An image, including any combination of graphics, text and images, may be communicated to the LEP printing apparatus 1. According to an illustrative example, in order to print the LEP ink composition, firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. The liquid electrophotographic ink composition is then transferred to the photo-imaging cylinder 4 by Binary Ink Developer (BID) unit 6. The BID unit 6 presents a uniform film of the liquid electrophotographic ink composition to the photo-imaging cylinder 4. The ink particles of the liquid electrophotographic ink composition may be electrically charged by virtue of an appropriate potential applied to the liquid electrophotographic ink composition in the BID unit. The charged ink particles are attracted, by virtue of an appropriate potential on the electrostatic image areas, to the latent electrostatic image on the photo-imaging cylinder 4. The electrophotographic ink composition does not adhere to the uncharged, non-image areas and forms a developed image on the surface of the latent electrostatic image. The photo-imaging cylinder 4 then has a developed electrophotographic ink composition image on its surface.

The developed image is then transferred from the photo-imaging cylinder 4 to the intermediate transfer member (ITM) 8 by virtue of an appropriate potential applied between the photo-imaging cylinder 4 and the ITM 8, such that the charged electrophotographic ink composition is attracted to the ITM 8. The developed image is then dried and fused on the ITM 8 before being transferred to a substrate 10.

Between the transfer of the developed image onto the ITM and the transfer of the developed image to the substrate from the ITM the solid content of the electrophotographic ink composition image is increased and the electrophotographic ink composition is fused on to the ITM 8. For example, the solid content of the electrophotographic ink composition image deposited on the ITM 8 is typically around 20%, whereas when the image is transferred to the substrate from the ITM the solid content of the image is typically around 80-90%. This drying and fusing is typically achieved by using elevated temperatures and air flow assisted drying. In some examples, the ITM 8 is heatable.

The present disclosure also provides a substrate having printed thereon an LEP ink composition as described herein and/or producible according to the method described herein.

### EXAMPLES

The following illustrates examples of the compositions and related aspects described herein. Thus, these examples should not be considered to restrict the present disclosure, but are merely in place to teach how to make examples of compositions of the present disclosure. As used herein, % AOWP stands for percentage agent by weight of pigment and is the weight of the agent (amine-containing dispersant, amine-containing compound or urea) per 100 g of colorant, that is, the wt. % by weight of the colorant.

### Example 1

An LEP ink composition was prepared by grinding 5.09 g of urea with 63.6 g of cyan pigment (a mixture of Lionol™ Blue FG-7351 (59.2 g; a pigment blue 15:3 pigment supplied by TOYO Company) and Heliogen Green™ D 8730 (4.4 g; a pigment green 7 pigment supplied by BASF™ company)) in Isopar L (a 1:10 wt/wt ratio of pigment and urea to Isopar L) at ambient temperature. The resulting mixture was then ground (using an S1 attritor at a speed of 250 rpm for 1.5 hours at 56° C. followed by 10.5 hours at 30° C.) with 1500 g of a resin paste (a mixture of Nucrel™ 699, available from DuPont™ and A-C 5120, available from Honeywell™, in a 4:1 weight ratio in Isopar™ L at 25 wt. % solids), 9.8 g of silica (DS72) and 10.8 g aluminium stearate (VCA, available from Sigma Aldrich™) in the presence of a carrier liquid (Isopar™ L; 720 to 730 g) to form a concentrated LEP ink.

The concentrated LEP ink was then diluted with additional carrier liquid (Isopar™ L) to 10 wt. % NVS to enable the thick, deep blue paste to be removed from the attritor. This concentrated LEP ink was then further diluted to 2 wt. % NVS to create a dispersion. The dispersion was then loaded with charge director to achieve a particle conductivity of 100 pmho/cm (HP imaging agent; 22 to 34 mg/g of solids) before printing. The cyan pigment loading of the LEP ink composition produced was 13.68 wt. % (primary pigment: 12.73 wt. %; secondary pigment: 0.95 wt. %) and the composition contained about 8% AOWP of urea.

The formulation of the LEP ink composition (excluding liquids and charge director) is provided in table 1 below.

TABLE 1

| Example 1 | | wt. % by |
|---|---|---|
| LEP ink Composition | Mass (g) | total solids |
| Cyan Pigment (primary pigment | 63.6 (59.2 | 13.68 (12.73 |
| (Lionol ™ Blue FG-7351) & | & 4.4) | & 0.95) |
| secondary pigment (Heliogen ™ | | |
| Green D 8730)) | | |
| Urea | 5.09 g | 1.09 |
| Resin paste (mixture of Nucrel ™ 699 | 375.75 | 80.80 |
| and A-C 5120 in a 4:1 weight ratio) | | |
| Aluminium stearate (VCA) | 10.8 | 2.32 |
| DS72 (Silica) | 9.8 | 2.11 |

### Example 2

An LEP ink composition was prepared by dissolving 1 g of an amine-containing basic dispersant (50 wt. % active dispersant in dipropylene glycol) having a TBN of about 400 mgKOH/g (Solplus® P6000, available from Lubrizol™) in 99 g of Isopar™ L and grinding with 63.6 g of cyan pigment (a mixture of Lionol™ Blue FG-7351 (59.2 g) and Heliogen™ Green D 8730 (4.4 g)) in a S1 attritor for 1.5 h at a temperature of 57° C., followed by 10.5 h at a temperature of 36° C., and a speed of 250 rpm. The resulting mixture was then ground (using an S1 attritor at a speed of 250 rpm for 1.5 hours at 56° C. followed by 10.5 hours at 30° C.) with 1500 g of a resin paste (a mixture of Nucrel™ 699, available from DuPont™, and A-C 5120, available from Honeywell™, in a 4:1 weight ratio in Isopar™ L at 25 wt. % solids), 9.8 g of silica (DS72, available as Aerosil™ R 7200 from Degussa-Evonik™) and 10.8 g aluminium stearate (VCA, available from Sigma Aldrich™) in the presence of a carrier liquid (Isopar™ L; 720 to 730 g) to form a concentrated LEP ink.

The concentrated LEP ink was then diluted with additional carrier liquid (Isopar™ L) to 10 wt. % NVS to enable the thick, deep blue paste to be removed from the attritor. This concentrated LEP ink was then further diluted to 2 wt. % NVS to create a dispersion. The dispersion was then loaded with charge director to achieve a particle conductivity of 100 pmho/cm (HP imaging agent; 22 to 34 mg/g of solids) before printing. The cyan pigment loading of the LEP ink composition produced was 13.81 wt. % (primary cyan pigment: 12.86 wt. %; secondary cyan pigment: 0.96 wt. %) and the composition contained about 0.79% AOWP of amine-containing basic dispersant.

The formulation of the LEP ink composition (excluding liquids and charge director) is provided in table 2 below.

TABLE 2

| Example 2 | | wt. % by |
|---|---|---|
| LEP ink Composition | Mass (g) | total solids |
| Cyan Pigment (primary pigment | 63.6 (59.2 | 13.81 (12.86 |
| (Lionol ™ Blue FG-7351) & | & 4.4) | & 0.96) |
| secondary pigment (Heliogen ™ | | |
| Green D 8730)) | | |
| Actives of Basic dispersant | 0.5 | 0.11 |
| (Solplus ® P6000) | | |
| Resin paste (mixture of Nucrel ™ 699 | 375.75 | 81.60 |
| and A-C 5120 in a 4:1 weight ratio) | | |
| Aluminium stearate (VCA) | 10.8 | 2.35 |
| DS72 (Silica) | 9.8 | 2.13 |

### Example 3

An LEP ink composition was prepared by following the procedure described for Example 2 except that 2 g of the amine-containing basic dispersant (Solplus® P6000) was used instead of 1 g. The cyan pigment loading of the LEP ink composition produced was 13.80 wt. % (primary pigment: 12.84 wt. %; secondary pigment: 0.95 wt. %) and the composition contained about 1.57% AOWP of amine-containing basic dispersant.

The formulation of the LEP ink composition (excluding liquids and charge director) is provided in table 3 below.

TABLE 3

| Example 3 | | wt. % by |
|---|---|---|
| LEP ink Composition | Mass (g) | total solids |
| Cyan Pigment (primary pigment | 63.6 (59.2 | 13.80 (12.84 |
| (Lionol ™ Blue FG-7351) & | & 4.4) | & 0.95) |
| secondary pigment (Heliogen ™ | | |
| Green D 8730)) | | |
| Actives of Basic dispersant | 1 | 0.22 |
| (Solplus ® P6000) | | |
| Resin paste (mixture of Nucrel ™ 699 | 375.75 | 81.52 |
| and A-C 5120 in a 4:1 weight ratio) | | |
| Aluminium stearate (VCA) | 10.8 | 2.34 |
| DS72 (Silica) | 9.8 | 2.13 |

### Example 4

An LEP ink composition was prepared by following the procedure described for Example 2 except that 2 g of the amine-containing basic dispersant (Solplus® P6000) was used instead of 1 g and twice the amount of VCA was included. The cyan pigment loading of the LEP ink composition produced was 13.48 wt. % (primary pigment: 12.55 wt. %; secondary pigment: 0.93 wt. %) and the composition contained about 1.57% AOWP of amine-containing basic dispersant.

The formulation of the LEP ink composition (excluding liquids and charge director) is provided in table 4 below.

TABLE 4

| Example 4 | | wt. % by |
|---|---|---|
| LEP ink Composition | Mass (g) | total solids |
| Cyan Pigment (primary pigment | 63.6 (59.2 | 13.48 (12.55 |
| (Lionol ™ Blue FG-7351) & | & 4.4) | & 0.93) |
| secondary pigment (Heliogen ™ | | |
| Green D 8730)) | | |
| Actives of Basic dispersant | 1 | 0.21 |
| (Solplus ® P6000) | | |
| Resin paste (mixture of Nucrel ™ 699 | 375.75 | 79.65 |
| and A-C 5120 in a 4:1 weight ratio) | | |
| Aluminium stearate (VCA) | 21.6 | 4.58 |
| DS72 (Silica) | 9.8 | 2.08 |

### Example 5

An LEP ink composition was prepared by following the procedure described for Example 2 except that 5 g of the amine-containing basic dispersant (Solplus® P6000) was used instead of 1 g. The cyan pigment loading of the LEP ink composition produced was 13.75 wt. % (primary pigment: 12.80 wt. %; secondary pigment: 0.95 wt. %) and the composition contained about 3.93% AOWP of amine-containing basic dispersant.

The formulation of the LEP ink composition (excluding liquids and charge director) is provided in table 5 below.

TABLE 5

| Example 5 | | wt. % by |
|---|---|---|
| LEP ink Composition | Mass (g) | total solids |
| Cyan Pigment (primary pigment | 63.6 (59.2 | 13.75 (12.80 |
| (Lionol ™ Blue FG-7351) & | & 4.4) | & 0.95) |
| secondary pigment (Heliogen ™ | | |
| Green D 8730)) | | |
| Actives of Basic dispersant | 2.5 | 0.54 |
| (Solplus ® P6000) | | |
| Resin paste (mixture of Nucrel ™ 699 | 375.75 | 81.25 |
| and A-C 5120 in a 4:1 weight ratio) | | |
| Aluminium stearate (VCA) | 10.8 | 2.34 |
| DS72 (Silica) | 9.8 | 2.12 |

### Example 6

An LEP ink composition was prepared by following the procedure described for Example 2 except that 1 g of mono ethanol amine (MEA) was used instead of the amine-containing basic dispersant. The cyan pigment loading of the LEP ink composition produced was 13.80 wt. % (primary pigment: 12.84 wt. %; secondary pigment: 0.95 wt. %) and the composition contained about 1.6% AOWP of mono ethanol amine. Mono ethanol amine has a pKa of 9.50 at 25° C. in water.

The formulation of the LEP ink composition (excluding liquids and charge director) is provided in table 6 below.

TABLE 6

| Example 6 | | wt. % by |
|---|---|---|
| LEP ink Composition | Mass (g) | total solids |
| Cyan Pigment (primary pigment | 63.6 (59.2 | 13.80 (12.84 |
| (Lionol ™ Blue FG-7351) & | & 4.4) | & 0.95) |
| secondary pigment (Heliogen ™ | | |
| Green D 8730)) | | |
| Mono ethanol amine | 1 | 0.22 |
| Resin paste (mixture of Nucrel ™ 699 | 375.75 | 81.52 |
| and A-C 5120 in a 4:1 weight ratio) | | |
| Aluminium stearate (VCA) | 10.8 | 2.34 |
| DS72 (Silica) | 9.8 | 2.13 |

### Reference Example 1

A reference LEP ink composition was prepared by following the procedure described for Example 1 except that no urea was used.

The formulation of the LEP ink composition (excluding liquids and charge director) is provided in table 7 below.

TABLE 7

| Reference Example 1 | | wt. % by |
|---|---|---|
| LEP ink Composition | Mass (g) | total solids |
| Cyan Pigment (primary pigment | 63.6 (59.2 | 13.83 (12.87 |
| (Lionol ™ Blue FG-7351) & secondary | & 4.4) | & 0.96) |
| pigment (Heliogen Green ™ D 8730)) | | |
| Resin paste (mixture of Nucrel ™ 699 | 375.75 | 81.69 |
| and A-C 5120 in a 4:1 weight ratio) | | |
| Aluminium stearate (VCA) | 10.8 | 2.35 |
| DS72 (Silica) | 9.8 | 2.13 |

### Tests

The compositions produced according to Examples 1 to 6 and Reference Example 1 were printed onto print substrates (Euroart™ paper (115 g/m²)) by using a LEP printing apparatus (HP Indigo™ 7000 press). The composition of each of Examples 1 to 6 and Reference Example 1 was used to print 3500 impressions (3.5 kimp) at 0% coverage. The optical density (OD) was determined for the first print (i.e. 0 kimp) and the 3500^{th} (3.5 kimp) print (see Table 8 below), along with the particle conductivity (PC) of the ink used to produce the first (0 kimp) and the 3500^{th} (3.5 kimp) print.

The OD was measured using an optical densitometer from X-rite™ company (X-rite Exact™). The particle conductivity (PC) is calculated by the subtraction of low field conductivity (LF) form high field conductivity (HF), where the LF is measured using a LF probe and the HF is measured by Q/M device that measures electrophoretic conductivity at high field. Electrical fatigue is observed if the particle conductivity of the ink increases when exposed continuously to a high electric field.

TABLE 8

| | | wt. | | % | ΔOD/ |
|---|---|---|---|---|---|
| | | (g) | | AOWP | 3.5kimp |
| Ex. 1 | Urea | 5.09 | | 8 | −0.04 |
| Ex. 2 | Solplus ® | 1 | (actives: 0.5) | 0.79 | −0.09 |
| Ex. 3 | P6000 | 2 | (actives: 1) | 1.57 | −0.04 |
| Ex. 4 | | 2* | (actives: 1) | 1.57 | −0.04 |
| Ex. 5 | | 5 | (actives: 2.5) | 3.93 | −0.05 |

| | | | | |
|---|---|---|---|---|
| Ex. 6 | MEA | 1 | 1.6 | −0.04 |
| Ref. | None | 0 | 0 | −0.12 |
| Ex. 1 | | | | |

*includes twice as much VCA as all other examples.
AOWP = agent on weight of pigment (calculated as active agent weight on pigment)

When cyan electrical fatigue is shown, the ΔOD/3.5 kimp is between 0.1 and 0.3, meaning that the printed cyan ink becomes lighter. The preferred ink compositions provide a ΔOD/3.5 kimp of approximately 0.05 or less.

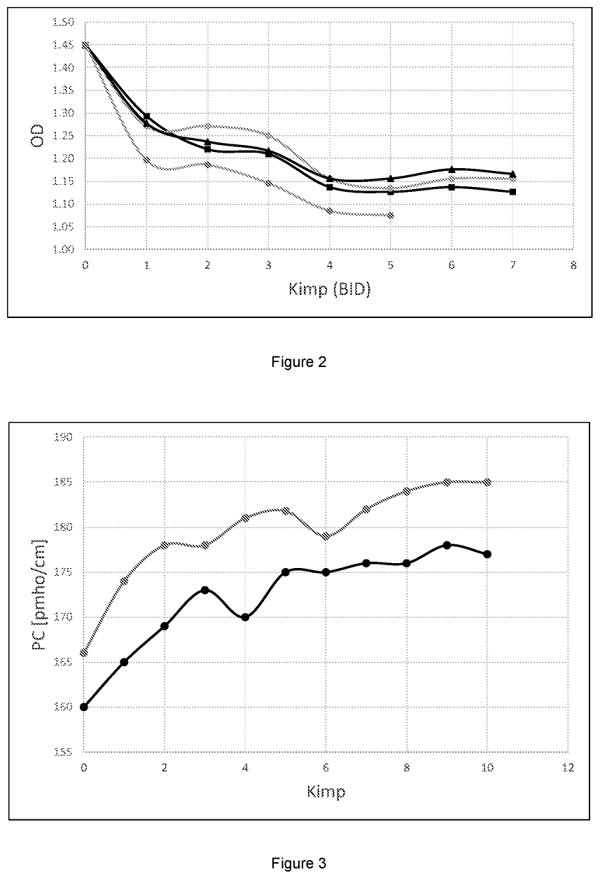

FIG. 2 shows the change in optical density of prints using Reference Example 1 during four different print runs of 7000 impressions (7 kimp) in which each print run was performed on a new binary ink developer (BID). As shown in the graph, the optical density of the images decreases significantly as the print run progresses. FIG. 3 shows the change in particle conductivity (PC) of the Reference Example 1 ink composition measured during two different print runs. This shows that the particle conductivity of the Reference Example 1 composition increases as the number of impressions printed increases. The differences between the test repeats in FIGS. 2 and 3 are a result of noise for these parameters. From a comparison of these two graphs, it has been observed that the change in particle conductivity correlates with the change in optical density.

Thus, the change in particle conductivity (ΔPC) of an ink has been found to correlate with the appearance of electrical fatigue. Therefore, a cyan ink with a high ΔPC (approximately 40 pmho/cm to 100 pmho/cm, in some examples, 40 pmho/cm to 50 pmho/com) shows electrical fatigue. Without wishing to be bound to any particular theory, it is believed that under the application of an electric field, a proton is detached from the acidic surface (for example, the acidic surface treatment) of the pigment, resulting in an excess of negative charge (which is stabilised due to the presence of a conjugated compound as or as part of the colorant) that manifests in increasing ink particle conductivity. To minimise electrical fatigue, a ΔPC of 20 or less is therefore desired.

It has been found that LEP inks containing an amine-containing dispersant with an amine-containing basic dispersant having a total base number greater than about 300 mgKOH/g, in particular, a total base number greater than about 350 mgKOH/g (for example, Solplus® P6000), or an amine-containing compound having a pKa of 8 or more at 25° C. (for example, mono ethanol amine), or urea address the electrical fatigue problem. LEP ink compositions comprising amine-containing dispersants having a TBN lower than 300 mgKOH/g [for example, Solsperse® 1330 (TBN: 200-250 mgKOH/g), Solsperse® 11200 (TBN: 100-110 mgKOH/g), Solsperse® J560 (TBN: 45-50 mgKOH/g), Solsperse® J561 (TBN: 70-80 mgKOH/g), and Efka 4320 (TBN: 28 mgKOH/g)], both alone and in the presence of an acidic synergist dispersant for cyan pigments (for example, Solsperse® 5000, which contains a synergist with phthalocyanine chemistry and acidic functional groups that enable the synergist to mediate between the basic dispersant and the mildly acidified phthalocyanine pigment) have also been tested. It was found that amine-containing dispersants having a TBN of greater than about 300 mgKOH/g (e.g. Solplus® P6000) were far more effective at reducing electrical fatigue of LEP ink compositions comprising cyan phthalocyanine pigments with a mildly acidic surface than the amine-containing dispersants having a TBN below 300 mgKOH/g. In view of the reduced effect of amine-containing dispersants having a TBN of below about 300 mgKOH/g on electrical fatigue, it is also believed that amine-containing compounds with a pKa of below 8 at 25° C. would be less effective at reducing electrical fatigue than amine-containing compounds with a pKa of 8 or more at 25° C.

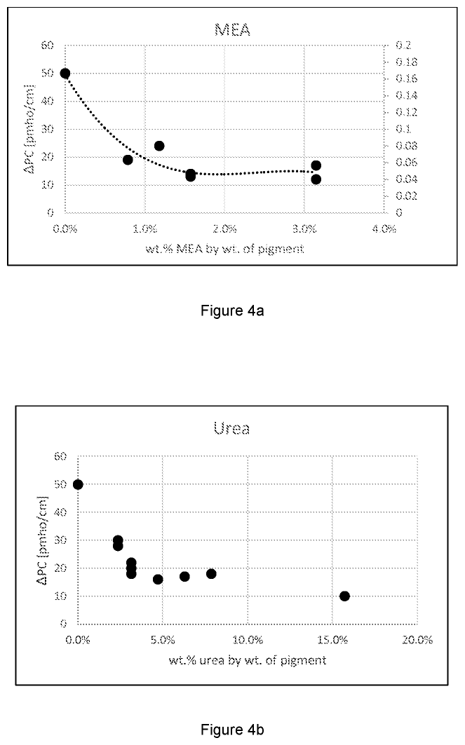

FIGS. 4a and 4b shows that the inclusion of mono ethanol amine (4a) or urea (4b) in the LEP ink composition reduces the change in particle conductivity (ΔPC) between the first (0 kimp) and 3500^{th} print cycle (3.5 kimp) of a print run on a binary ink developer (BID) unit of an LEP printing apparatus (HP Indigo 7000 press). Each graph shows the ΔPC for inks in which neither urea nor mono ethanol amine were included as the ΔPC at 0 wt. %.

As shown in FIG. 4 and Table 8 above, the presence of mono ethanol amine, urea or Solplus® P6000 in the LEP ink composition even in small amounts (as a wt. % of the wt. of colorant/pigment) dramatically reduces the change in PC (FIG. 4) and optical density (Table 8), both indicating a clear reduction in electrical fatigue. Thus, it has been found that providing LEP inks containing a component selected from an amine-containing dispersant, an amine compound and urea as described herein addresses the electrical fatigue problem and minimises the side effects of electrical fatigue, such as reduced optical density.

Although LEP ink compositions comprising a component selected from an amine-containing dispersant, an amine-containing compound and urea show a reduction in electrical fatigue, the presence of large amounts of the component selected from an amine-containing dispersant, an amine-containing compound and urea may increase adherence of the LEP ink composition to the intermediate transfer member, resulting in poor transfer from the intermediate transfer member to the print substrate. It is considered that the use of small amounts, such as, less than about 2 wt. % total solids, of the component selected from an amine-containing dispersant, an amine-containing compound and urea may reduce these transfer problems.

While the electrostatic ink compositions, methods and related aspects have been described with reference to certain examples, it will be appreciated that various modifications, changes, omissions, and substitutions can be made without departing from the spirit of the disclosure. It is intended, therefore, that the electrostatic ink compositions, methods and related aspects be limited only by the scope of the following claims. Unless otherwise stated, the features of any dependent claim can be combined with the features of any of the other dependent claims, and any other independent claim.

1. A liquid electrophotographic (LEP) ink composition comprising:
a hydrocarbon carrier liquid;
a resin;
a colorant comprising a conjugated compound; and
a component selected from:
an amine-containing basic dispersant having a total base number greater than about 300 mgKOH/g in an amount of up to about 10 wt. % by weight of the colorant; or
an amine-containing compound having a pKa of 8 or more at 25° C.; or
urea.

2. The LEP ink composition according to claim 1, wherein the composition comprises: the amine-containing basic dispersant in an amount from about 0.1 wt. % to about 10 wt. % by weight of the colorant.

3. The LEP ink composition according to claim 1, wherein the amine-containing basic dispersant has a total base number of at least about 350 mgKOH/g.

4. The LEP ink composition according to claim 1, wherein the wherein the composition comprises the amine-containing compound having a pKa of 8 or more at 25° C. in an amount of up to about 15 wt. % by weight of the colorant.

5. The LEP ink composition according to claim 1, wherein the wherein the composition comprises the amine-containing compound having a pKa of 8 or more at 25° C. in an amount of at least about 0.1 wt. % by weight of the colorant.

6. The LEP ink composition according to claim 1, wherein the wherein the composition comprises urea in an amount of up to about 20 wt. % by weight of the colorant.

7. The LEP ink composition according to claim 1, wherein the wherein the composition comprises urea in an amount of at least about 1 wt. % by weight of the colorant.

8. The LEP ink composition according to claim 1, wherein amine-containing compound has a pKa of about 9 or more at 25° C.

9. The LEP ink composition according to claim 1, wherein the amine-containing compound is mono ethanol amine.

10. The LEP ink composition according to claim 1, wherein the conjugated compound is selected from phthalocyanins, carbon black, quinacrodines, anthraquinones, antharones, diketopyrrolopyroles, perylenes, perinones, phthaleins, pyranthrones, indigoids, thioindigoids, pyrazoloquinazolones, heterocyclic compounds, benzimidazolones, indanthrones, bisoxazines, violanthrones, isoviolanthrones, aryl-substituted triazines, imine-substituted naphthols, azines, rhodamines or phenazines.

11. The LEP ink composition according to claim 1, wherein the conjugated compound is a phthalocyanin.

12. The LEP ink composition according to claim 1, wherein the colorant comprises pigment blue 15:3.

13. The LEP ink composition according to claim 1, comprising up to about 2 wt. % by total weight solids of the composition of the component selected from:
an amine-containing basic dispersant having a total base number greater than about 300 mgKOH/g in an amount of up to about 10 wt. % by weight of the colorant; or
an amine-containing compound having a pKa of 8 or more at 25° C.; or
urea.

14. A method of producing an LEP ink composition, the method comprising combining:
a hydrocarbon carrier liquid;
a resin;
a colorant comprising a conjugated compound; and
a component selected from:
an amine-containing basic dispersant having a total base number greater than about 300 mgKOH/g in an amount of up to about 10 wt. % by weight of the colorant; or
an amine-containing compound having a pKa of 8 or more at 25° C.; or
urea.

15. A method of electrostatic printing an LEP ink composition, the method comprising:
providing a LEP ink composition comprising:
a hydrocarbon carrier liquid;
a resin;
a colorant comprising a conjugated compound; and
a component selected from:
an amine-containing basic dispersant having a total base number greater than about 300 mgKOH/g in an amount of up to about 10 wt. % by weight of the colorant; or
an amine-containing compound having a pKa of 8 or more at 25° C.; or
urea; and
liquid electrostatically printing the LEP ink composition onto a substrate.
